(19) United States
(12) Patent Application Publication
(10) Pub. No.: US 2003/0197946 A1
(43) Pub. Date: Oct. 23, 2003

(54) Projection optical system, fabrication method thereof, exposure apparatus and exposure method

(75) Inventor: Yasuhiro Omura, Kumagaya (JP)

Correspondence Address: OLIFF & BERRIDGE, PLC, P.O. BOX 19928, ALEXANDRIA, VA, 22320, US

(73) Assignee: NIKON CORPORATION, Tokyo (JP)

(21) Appl. No.: 10/413,545

(22) Filed: Apr. 15, 2003

(30) Foreign Application Priority Data
Apr. 17, 2002 (JP) 2002-114209

(51) Int. Cl. G02B 5/30; G02B 27/28; G02B 3/00; G02B 9/00; G02B 17/00

(52) U.S. Cl. 359/649; 359/726; 359/494

(57) ABSTRACT

Disclosed is a projection optical system capable of ensuring good optical performance virtually without effects of birefringence of fluorite by for example, controlling an angle difference between an optical axis and a predetermined axis of a fluorite lens to a predetermined allowable amount. The projection optical system for forming an image of a first surface (R: reticle) on a second surface (W: wafer) includes at least two light-transmissive crystal members formed of a crystal material belonging to a cubic system. In at least the two light-transmissive crystal members, an angle difference is set at 1° between the optical axis and any one of crystal axes [111], [100] and [110].

### BACKGROUND OF THE INVENTION

1. Field of the Invention

The present invention relates to a projection optical system, a fabrication method thereof, an exposure apparatus and an exposure method. More particularly, the present invention relates to a catadioptric projection optical system suitable for an exposure apparatus used to fabricate microdevices such as semiconductor devices in a photolithography process.

2. Description of the Related Art

In recent years, progress has been made increasingly in microfabrication of semiconductor devices and semiconductor chip package substrates, and a projection optical system having a higher resolution has been demanded for an exposure apparatus which prints patterns. In order to satisfy the demand for such a high resolution, a wavelength of exposure light must be shortened, and a NA (numerical aperture) of the projection optical system must be increased. However, if the wavelength of the exposure light is shortened, the number of different types of optical materials, which can be practically used for light absorption, will be limited.

For example, in the case of using light in the vacuum ultraviolet range having a wavelength of 200 nm or less, particularly where F₂ laser light (wavelength: 157 nm) is employed as exposure light, fluoride crystals such as calcium fluoride (fluorite: CaF₂) and barium fluoride (BaF₂) must be used quite often as a light-transmissive optical material constituting the projection optical system. Practically, the projection optical system is presumed to be basically formed of only fluorite in a design of an exposure apparatus using F₂ laser light as the exposure light. The fluorite is a crystal belonging to a cubic system (isometric system), is optically isotropic, and has been assumed to have no birefringence virtually. Moreover, in the conventional experiments on the visible light range, only small birefringence (random phenomenon caused by internal stress) has been observed in fluorite.

However, at the symposium on lithography held on May 15, 2001 (2nd International Symposium on 157 nm Lithography), John H. Burnett, et al. of the U.S. National Institute of Standards and Technology (NIST) announced that they have experimentally and theoretically confirmed the existence of intrinsic birefringence in fluorite.

According to this announcement, birefringence of fluorite is virtually zero in the direction of the crystal axis [111] and in the direction of the crystal axes [−111], [1−11] and [11−1] equivalent thereto, and in the direction of the crystal axis [100] and in the direction of the crystal axes [010] and [001] equivalent thereto, but practically has nonzero values in other directions. Particularly, in the six directions of the crystal axes [110], [−110], [101], [−101], [011] and [01−1], fluorite has maximum birefringence of 11.2 nm/cm for the light having a wavelength of the 157 nm and of 3.4 nm/cm for the light having a wavelength of the 193 nm.

In the case of using lenses, which are generally light-transmissive members, thus formed of fluorite having the intrinsic birefringence for the projection optical system, effects of the fluorite birefringence are largely exerted on image-forming performance, and particularly, the effects are prominent in an in-surface line width error (ΔCD: critical dimension). Accordingly, in the above-described announcement, Burnett, et al. have proposed a method of mitigating the effects of the birefringence by making an optical axis and a crystal axis [111] of a pair of fluorite lenses (lenses formed of fluorite) coincide, and by making the pair of fluorite lenses be relatively rotated by 60° around the optical axis.

In general, it is not easy to incorporate the fluorite lens into the projection optical system in order for the optical axis and crystal axis [111] thereof to coincide precisely. In addition, it is not easy to incorporate a pair of the fluorite lenses precisely into the projection optical system in a state where the lenses are relatively rotated by a predetermined angle around the optical axis, either. However, in the projection optical system, it is important to control an angle difference between the optical axis and crystal axis [111] of the fluorite lens and a relatively rotational angle difference between the pair of fluorite lenses around the optical axis thereof to a predetermined allowable amount or less in order to ensure good optical performance virtually without effects of the birefringence.

Moreover, it has been clarified that there is a possibility that an area having an abnormal difference between orientations of the crystal axes exists locally in the fluorite crystal (so-called grain boundary). It is not preferable to use a fluorite crystal having such an area with an orientational difference between the crystal axes (hereinafter, referred to as “abnormal fluorite crystal”) in order to ensure desired optical performance. However, in reality, even the abnormal fluorite crystals must be used in terms of productivity and cost. In this case in the projection optical system, it is important to control the relative angle difference between the crystal axis orientations to the predetermined allowable amount or less in order to ensure good optical performance virtually without effects of the birefringence.

### SUMMARY OF THE INVENTION

In consideration of the foregoing problems, it is one object of the present invention to provide a projection optical system controlling, to the predetermined allowable amount or less, the angle difference between the optical axis and crystal axis of, for example, a fluorite optical member (typically, a fluorite lens), or the relatively rotational angle difference between the pair of fluorite optical members (typically, fluorite lenses) around the optical axis, thus making it possible to ensure good optical performance virtually without effects of the birefringence of fluorite, and to provide a fabrication method thereof.

Moreover, it is another object of the present invention to provide a projection optical system controlling, to the predetermined allowable amount or less, the relative angle difference between the crystal axis orientations in the abnormal fluorite crystals, for example, for forming the fluorite optical member (typically, a fluorite lens), thus making it possible to ensure good optical performance virtually without effects of the birefringence of fluorite.

Furthermore, it is still another object of the present invention to provide an exposure apparatus and an exposure method, which are capable of performing high-resolution and high-precision projection exposure by using the projection optical system having good optical performance virtually without effects of the birefringence of fluorite.

In order to achieve the foregoing objects, a first aspect of the present invention provides a projection optical system for forming an image of a first surface on a second surface, comprising:

at least two light-transmissive crystal members formed of a crystal material belonging to a cubic system,

wherein at least one of an angle difference between an optical axis and any one of crystal axes [111], [100] and [110] in at least the two light-transmissive crystal members and an angle difference of a relatively rotational angle between predetermined crystal axes around the optical axis from a predetermined value in at least the two light-transmissive crystal members is set at 1° or less.

In a preferred embodiment of the first aspect of the present invention, the angle difference between the optical axis and any one of the crystal axes [111], [100] and [110] in at least the two light-transmissive crystal members is set at 1° or less. In this case, it is preferable that the projection optical system further comprise a light-transmissive crystal member arranged closest to the second surface, and that an angle difference between an optical axis and any one of crystal axes [111], [100] and [110] is set at 1° or less in the light-transmissive crystal member arranged closest to the second surface.

Moreover, according to the preferred embodiment of the first aspect of the present invention, the projection optical system further comprises: a concave reflective mirror; and a light-transmissive crystal member arranged in a vicinity of the concave reflective mirror, wherein an angle difference between an optical axis and any one of crystal axes [111], [100] and [110] is set at 1° or less in the light-transmissive crystal member arranged in the vicinity of the concave reflective mirror. It is preferable that the projection optical system is a catadioptric and image re-forming optical system for forming an intermediate image of the image of the first surface in an optical path between the first surface and the second surface.

Furthermore, according to the preferred embodiment of the first aspect of the present invention, the projection optical system further comprises: a first image-forming optical system for forming a first intermediate image of the image of the first surface; a second image-forming optical system including at least one concave reflective mirror and at least one light-transmissive crystal member and for forming a second intermediate image based on a light (radiation) beam from the first intermediate image; a third image-forming optical system for forming a final image on the second surface based on a light beam from the second intermediate image; a first deflection mirror (a first folding mirror) arranged in an optical path between the first image-forming optical system and the second image-forming mirror) arranged in an optical path between the second image-forming optical system and the third image-forming optical system, wherein an optical axis of the first image-forming optical system and an optical axis of the third image-forming optical system are set to virtually coincide (are coaxial), and an angle difference between an optical axis and any one of crystal axes [111], [100] and [110] is set at 1° or less in the light-transmissive crystal member arranged in an optical path of the second image-forming optical system.

Moreover, according to the preferred embodiment of the first aspect of the present invention, an angle difference between an optical axis and any one of crystal axes [111], [100] and [110] is set at 1° or less in more than or equal to 15% of all the light-transmissive crystal members included in the projection optical system. In addition, it is preferable that an angle difference between an optical axis and any one of crystal axes [111], [100] and [110] is set at 2° or less in all the light-transmissive crystal members included in the projection optical system.

A second aspect of the present invention provides a projection optical system for forming an image of a first surface on a second surface, comprising:

at least two light-transmissive crystal members formed of a crystal material belonging to a cubic system,

wherein, when an area having a difference between orientations of crystal axes exists in at least the two light-transmissive crystal members, relative angle difference thereof is 2° or less.

According to a preferred embodiment of the second aspect of the present invention, the projection optical system further comprises a light-transmissive crystal member arranged closest to the second surface, wherein, when an area having a difference between orientations of crystal axes exists in the light-transmissive crystal member arranged closest to the second surface, relative angle difference thereof is 2° or less. Moreover, it is preferable that the projection optical system further comprise: a concave reflective mirror; and a light-transmissive crystal member arranged in a vicinity of the concave reflective mirror, and that, when an area having a difference between orientations of crystal axes exists in the light-transmissive crystal member arranged in the vicinity of the concave reflective mirror, relative angle difference thereof is 2° or less. In this case, it is preferable that the projection optical system is a catadioptric and image re-forming optical system for forming an intermediate image of the image of the first surface in an optical path between the first surface and the second surface.

Moreover, according to the preferred embodiment of the second aspect of the present invention, the projection optical system further comprises: a first image-forming optical system for forming a first intermediate image of the image of the first surface; a second image-forming optical system including at least one concave reflective mirror and at least one light-transmissive crystal member and for forming a second intermediate image based on a light beam from the first intermediate image; a third image-forming optical system for forming a final image on the second surface based on a light beam from the second intermediate image; a first deflection mirror (a first folding mirror) arranged in an optical path between the first image-forming optical system and the second image-forming optical system; and a second deflection mirror (a second folding mirror) arranged in an optical path between the second image-forming optical system and the third image-forming optical system, wherein an optical axis of the first image-forming optical system and an optical axis of the third image-forming optical system are set to virtually coincide (are coaxial), and when an area having a difference between orientations of crystal axes exists in the light-transmissive crystal member arranged in the optical path of the second image-forming optical system, relative angle difference thereof is 2° or less.

Furthermore, according to the preferred embodiment of the second aspect of the present invention, when an area having a difference between orientations of crystal axes exits in all the light-transmissive crystal members included in the projection optical system, relative angle difference thereof is 2° or less. Note that, in the first and second aspect of the present invention, it is preferable that the crystal material belonging to the cubic system is calcium fluoride or barium fluoride.

A third aspect of the present invention provides an exposure apparatus comprising: an illumination system for illuminating a mask set on the first surface; and the projection optical system, according to the first or second aspect of the present invention, for forming a pattern image formed on the mask on a photosensitive substrate set on the second surface.

A fourth aspect of the present invention provides an exposure method comprising the steps of: illuminating a mask set on the first surface; and projecting and exposing a pattern image, formed on the mask through the projection optical system according to the first or second aspect of the present invention, on a photosensitive substrate set on the second surface.

A fifth aspect of the present invention provides a fabrication method of a projection optical system including at least two light-transmissive crystal members formed of a crystal material belonging to a cubic system and for forming an image of a first surface on a second surface, the method of comprising:

a design step of designing to allow an optical axis of each of at least the two light-transmissive crystal members to coincide with any one predetermined crystal axis of crystal axes [111], [100] and [110]; and

a fabrication step of fabricating at least the two light-transmissive crystal members such that an angle difference is set at 1° or less between the predetermined crystal axis and the optical axis.

According to a preferred embodiment of the fifth aspect of the present invention, the fabrication step includes the steps of: adjusting a cutout of a disk material from a single crystal ingot; and adjusting a polishing of the disk material. In addition, it is preferable that at least the two light-transmissive crystal members include first and second light-transmissive crystal members, and that the fabrication step includes a setting step of setting an angle difference of a relatively rotational angle between the predetermined crystal axes of the first and second light-transmissive crystal members around the optical axis with respect to a predetermined design value at 5° or less.

A sixth aspect of the present invention provides an exposure apparatus comprising: an illumination system for illuminating a mask set on the first surface; and the projection optical system fabricated by the fabrication method, according to the fifth aspect of the present invention, for forming a pattern image formed on the mask on a photosensitive substrate set on the second surface.

A seventh aspect of the present invention provides an exposure method comprising the steps of: illuminating a mask set on the first surface; and projecting and exposing a pattern image, formed on the mask through the projection optical system fabricated by the fabrication method according to the fifth aspect of the present invention, on a photosensitive substrate set on the second surface. The present invention will be more fully understood from the detailed description given hereinbelow and the accompanying drawings, which are given by way of illustration only and are not to be considered as limiting the present invention.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will be apparent to those skilled in the art from this detailed description.

### BRIEF DESCRIPTION OF THE DRAWINGS

FIG. 1 is a diagram illustrating crystal axis orientations of fluorite;

FIGS. 2A to 2C are views illustrating a method of Burnett, et al. and showing a distribution of birefringence indices with respect to an incident angle of a light beam;

FIGS. 3A to 3C are views illustrating a first method proposed in the present invention and showing a distribution of birefringence indices with respect to an incident angle of a light beam;

FIGS. 4A to 4C are views illustrating a second method proposed in the present invention and showing a distribution of birefringence indices with respect to an incident angle of a light beam;

FIG. 5 is a diagram schematically illustrating a constitution of an exposure apparatus having a projection optical system according to embodiments of the present invention;

FIG. 6 is a diagram illustrating a positional relationship between a rectangular exposure region (i.e., effective exposure region) formed on a wafer and a reference optical axis;

FIG. 7 is a diagram illustrating a constitution of lenses in a projection optical system according to a first embodiment of the present embodiments;

FIG. 8 is a diagram illustrating transverse aberrations in the first embodiment;

FIG. 9 is a diagram illustrating a constitution of lenses in a projection optical system according to a second embodiment of the present embodiments;

FIG. 10 is a diagram showing transverse aberrations in the second embodiment;

FIG. 11 is a graph showing variations of in-surface line widths when an angle difference of 1° is formed between a crystal axis and an optical axis of each fluorite lens in the first embodiment;

FIG. 12 is a graph showing variations of in-surface line widths when an angle difference of 1° is formed between a crystal axis and an optical axis of each fluorite lens in the second embodiment;

FIG. 13 is a flowchart schematically showing a fabrication method of the projection optical system according to the embodiments of the present invention;

FIG. 14 is a flowchart specifically showing a crystal material preparation process of preparing a crystal material of an isometric system, which is light-transmissive for a wavelength for which the projection optical system is used;

FIG. 15 is a diagram schematically illustrating a Laue camera;

FIG. 16 is a diagram illustrating a schematic constitution of a birefringence measurement apparatus;

FIG. 17 is a flowchart of a method used to obtain a semiconductor device employed as a microdevice; and

FIG. 18 is a flowchart of a method used to obtain a liquid crystal display device employed as a microdevice.

### DETAILED DESCRIPTION OF PREFERRED EMBODIMENTS

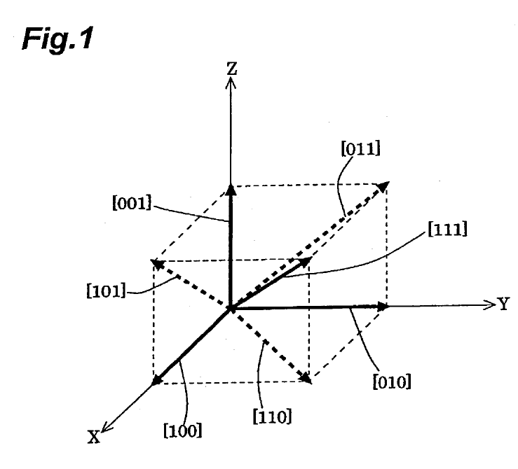

FIG. 1 is a diagram illustrating crystal axis orientations of fluorite. Referring to FIG. 1, the crystal axes of the fluorite are defined based on an XYZ coordinate system of a cubic system. Specifically, the crystal axes [100], [010] and [001] are defined along the +X axis, the +Y axis and the +Z axis, respectively.

Moreover, the crystal axis [101] is defined on the XZ plane in the direction forming a 45° angle with the crystal axes [100] and [001], the crystal axis [110] is defined on the XY plane in the direction forming a 45° angle with the crystal axes [100] and [010], and the crystal axis [011] defined on the YZ plane in the direction forming a 45° angle with the crystal axes [010] and [001]. Furthermore, the crystal axis [111] is defined in the direction forming an equivalent acute angle with each of the +X, +Y and +Z axes.

Note that, crystal axes are also defined in other spaces though only the crystal axes in the space defined by the +X, +Y and +Z axes are illustrated in FIG. 1. For fluorite, its birefringence is virtually zero (minimum) in the direction of the crystal axis indicated [111] by the solid line in FIG. 1 and in the directions of the unillustrated crystal axes [−111], [1−11] and [11−1] equivalent thereto. Similarly, the birefringence is also virtually zero (minimum) in the directions of the crystal axes [100], [010] and [001] indicated by the solid lines in FIG. 1. On the other hand, the birefringence is maximum in the directions of the crystal axes [110], [101] and [011] indicated by the broken lines in FIG. 1, and in the directions of the unillustrated crystal axes [−110], [−101] and [01−1] equivalent thereto.

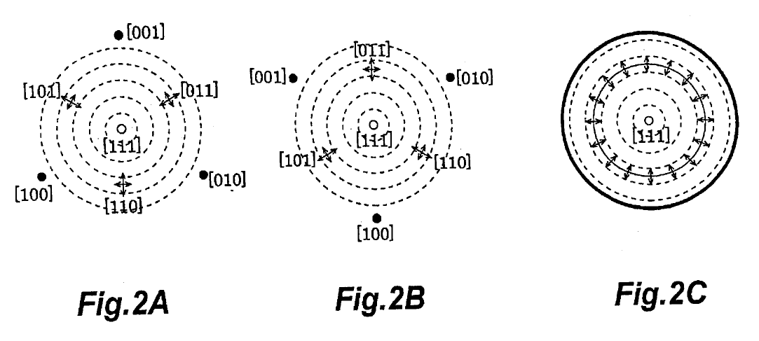

Burnett, et al. have disclosed a method of mitigating the effects of birefringence in the aforementioned announcement. FIGS. 2A to 2C are views illustrating the method of Burnett, et al. and showing a distribution of birefringence indices with respect to an incident angle of a light beam (angle formed by light beam and optical axis). In FIGS. 2A to 2C, the five concentric circles indicated by broken lines show a scale of 10° per circle. Accordingly, the innermost circle represents the area of an incident angle of 10° with respect to the optical axis, and the outermost circle represents the area of an incident angle of 50° with respect to the optical axis.

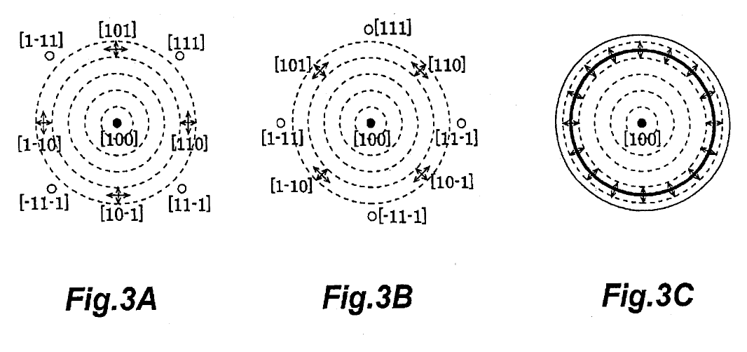

In addition, the closed mark indicates areas having a relatively high refractive index but no birefringence, the open mark indicate areas having a relatively low refractive index but no birefringence. Meanwhile, the circle with thick rim and the long double-headed arrows indicate the directions of relatively high refractive indices in areas having birefringence, and the circle with thin rim and short double-headed arrows indicate the directions of relatively low refractive indices in areas having birefringence. The notation in FIGS. 3A to 3C are the same as the above-described notation.

In the method of Burnett, et al, the optical axis and crystal axis [111] or an crystal axis optically equivalent to the crystal axis [111] of a pair of fluorite lenses (lenses formed of fluorite) are coincided, and the pair of fluorite lenses is relatively rotated by 60° around the optical axis. Accordingly, the distribution of birefringence indices in one of the fluorite lenses becomes as shown in FIG. 2A, and the distribution of birefringence indices in the other fluorite lens becomes as shown in FIG. 2B. As a result, the distribution of birefringence indices over the pair of fluorite lenses becomes as shown in FIG. 2C.

In this case, referring to FIGS. 2A and 2B, the area corresponding to the crystal axis [111] that coincides with the optical axis becomes an area having a relatively low refractive index but no birefringence. In addition, the areas corresponding to the crystal axes [100], [010] and [001] become areas having relatively high refractive indices but no birefringence. Furthermore, the areas corresponding to the crystal axes [110], [101] and [011] become birefringence areas with relatively low refractive indices with respect to tangential polarized light and relatively high refractive indices with respect to radial polarized light. Thus, it is understood that the each of the fluorite lenses is affected by birefringence most in an area of 35.26° from the optical axis (the angle formed by the crystal axis [111] and the crystal axis [110]).

Meanwhile, referring to FIG. 2C, it is understood that the effects of birefringence on the crystal axes [110], [101] and [011], where at the maximum, are reduced over the pair of fluorite lenses by relatively rotating the pair of fluorite lenses by 60°. Then, in an area at 35.26° from the optical axis, a birefringence area remains, which has a lower refractive index with respect to tangential polarized light than a refractive index with respect to radial polarized light. In other words, the effects of birefringence can be reduced considerably by using the method of Burnett, et al. though a rotationally symmetric distribution with respect to the optical axis remains.

Moreover, in the first method proposed in the present invention, the optical axis of the pair of fluorite lenses (light-transmissive members formed of fluorite in general) is coincided with the crystal axis [100] (or a crystal axis optically equivalent to the crystal axis [100]), and the pair of fluorite lenses is relatively rotated by approximately 45° around the optical axis. Here, the crystal axes [010] and [001] are optically equivalent to the crystal axis [100].

FIGS. 3A to 3C are views illustrating the first method proposed in the present invention and showing a distribution of birefringence indices with respect to an incident angle of a light beam (angle formed by the light beam and the optical axis). In the first method proposed in the present invention, the distribution of birefringence indices in one of the fluorite lenses becomes as shown in FIG. 3A, and the distribution of birefringence indices in the other fluorite lens becomes as shown in FIG. 3B. As a result, the distribution of birefringence indices over the pair of fluorite lenses becomes as shown in FIG. 3C.

Referring to FIGS. 3A and 3B, in the first method proposed in the present invention, the area corresponding to the crystal axis [100] that coincides with the optical axis has a relatively high refractive index but no birefringence. In addition, the areas corresponding to the crystal axes [111], [1−11], [−11−1] and [11−1] have a relatively low refractive index but no birefringence. Furthermore, the areas corresponding to the crystal axes [101], [10−1], [110] and [1−10] are birefringence areas having a relatively high refractive index with respect to tangential polarized light and a relatively low refractive index with respect to radial polarized light. Thus, it is understood that each of the fluorite lenses is affected by birefringence most in the area of 45° from the optical axis (the angle formed by the crystal axis [100] and the crystal axis [101]).

Meanwhile, referring to FIG. 3C, the effects of birefringence on the crystal axes [101], [10−1], [110] and [1−10], where at the maximum, are considerably reduced over the pair of fluorite lenses by relatively rotating the pair of fluorite lenses by 45°, and in an area at 45° from the optical axis, a birefringence area having a higher refractive index with respect to tangential polarized light than a refractive index with respect to radial polarized light remains. In other words, the effects of birefringence can be reduced considerably by using the first method proposed in the present invention though the rotationally symmetric distribution with respect to the optical axis remains.

Note that, in the first method proposed in the present invention, relatively rotating one of the fluorite lenses and the other fluorite lens by approximately 45° around the optical axis means that the relative angle around the optical axis is approximately 45° between two predetermined crystal axes (e.g., two of crystal axes [010], [001], [011] and [01−1]) oriented in different directions from the optical axes in these fluorite lenses. Concretely, this means that the relative angle around the optical axis is approximately 45° between the crystal axis [010] in one of the fluorite lenses and the crystal axis [010] in the other fluorite lens, for example.

In addition, as clearly shown in FIGS. 3A and 3B, when the crystal axis [100] is set as the optical axis, rotational asymmetry of the effects of birefringence around the optical axis appears with a period of 90°. Accordingly, relatively rotating around the optical axis by approximately 45° means relatively rotating around the optical axis by approximately 45°+(n×90°), in other words, relatively rotating around the optical axis by 45°, 135°, 225°, 315° and so on (where n is an integer).

In the meantime, relatively rotating one of the fluorite lenses and the other fluorite lens around the optical by approximately 60° in the method of Burnett, et al. means that the relative angle around the optical axis is approximately 60° between two predetermined crystal axes (e.g., two of crystal axes [−111], [11−1] and [1−11]) oriented in different directions from the optical axes in these fluorite lenses. Concretely, this means, for example, that the relative angle around the optical axis is approximately 60° between the crystal axis [−111] in the one of the fluorite lenses and the crystal axis [−111] in the other fluorite lens.

In addition, as clearly shown in FIGS. 2A and 2B, when the crystal axis [111] is set as the optical axis, rotational asymmetry of the effects of birefringence around the optical axis appears with a period of 120°. Accordingly, in the method of Burnett, et al., relatively rotating around the optical axis by approximately 60° means relatively rotating around the optical axis by approximately 60°+(n×120°), in other word, relatively rotating around the optical axis by 60°, 180°, 300° and so on (where n is an integer).

Moreover, in the second method proposed in the present invention, the optical axis of the pair of fluorite lenses (in general, light-transmissive members formed of fluorite) is coincided with the crystal axis [110] (or a crystal axis optically equivalent to the crystal axis [110]) and the pair of fluorite lenses is relatively rotated by approximately 90° around the optical axis. Here, the crystal axes optically equivalent to the crystal axis [110] are the crystal axes [−110], [101], [−101], [011] and [01−1].

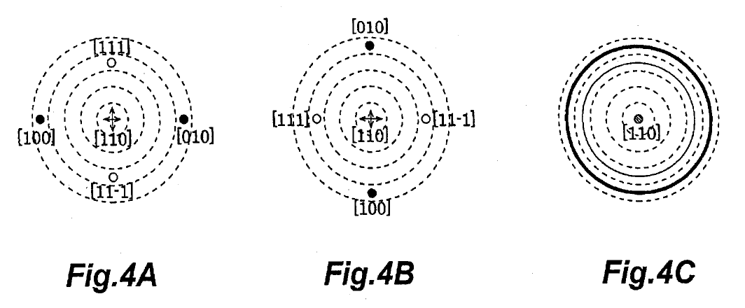

FIGS. 4A to 4C are views illustrating the second method proposed in the present invention and showing a distribution of birefringence indices with respect to an incident angle of a light beam. In the second method proposed in the present invention, the distribution of birefringence indices in one of the fluorite lenses becomes as shown in FIG. 4A, and the distribution of birefringence indices in the other fluorite lens becomes as shown in FIG. 4B. As a result, the distribution of of birefringence indices over the pair of fluorite lenses becomes as shown in FIG. 4C.

Referring to FIGS. 4A and 4B, in the second method proposed in the present invention, the area corresponding to the crystal axis [110] that coincides with the optical axis is a birefringence area having a relatively high refractive index with respect to polarized light in one direction and a relatively low refractive index with respect to polarized light in the other direction (direction orthogonal to the one direction). The areas corresponding to the crystal axes [100] and [010] are areas having a relatively high refractive index but no birefringence. Furthermore, the areas corresponding to the crystal axes [111] and [11−1] are areas having a relatively low refractive index but no birefringence.

Meanwhile, referring to FIG. 4C, the crystal axis [110], where the effects of birefringence is at the maximum, hardly affects over the pair of fluorite lenses by relatively rotating the pair of fluorite lenses by 90°, and the vicinity of the optical axis becomes an area having an average refractive index but no birefringence. In other words, good image-forming performance can be ensured virtually without the effects of the birefringence by using the second method proposed in the present invention.

Note that, in the second method proposed in the present invention, relatively rotating one of the fluorite lenses and the other fluorite lens by approximately 90° around the optical axis means that the relative angle around the optical axis is approximately 90° between two predetermined crystal axes (e. g., two of crystal axes [001], [−111], [−110] and [1−11]) oriented in different directions from the optical axes in the one of the fluorite lenses and the other fluorite lens. Concretely, this means, for example, that the relative angle around the optical axis is approximately 90° between the crystal axes [001] in the one of the fluorite lenses and the crystal axis [001] in the other fluorite lens.

In addition, as clearly shown in FIGS. 4A and 4B, when the crystal axis [110] is set as the optical axis, rotational asymmetry of the effects of birefringence around the optical axis appears with a period of 180°. Accordingly, in the second method proposed in the present invention, relatively rotating by approximately 90° around the optical axis means relatively rotating around the optical axis by approximately 90°+(n×180°), in other words, relatively rotating around the optical axis by 90°, 270° and so on (where n is an integer).

As described above, the optical axis of the pair of fluorite lenses is coincided with the crystal axis [111], and the pair of fluorite lenses is relatively rotated by 60° around the optical axis. Alternatively, the optical axis of the pair of fluorite lenses is coincided with the crystal axis [100], and the pair of fluorite lenses is relatively rotated by 45° around the optical axis. Alternatively, the optical axis of the pair of fluorite lenses is coincided with the crystal axis [110], and the pair of fluorite lenses is relatively rotated by 90° around the optical axis. Thus, the effects of birefringence can be considerably reduced.

As previously mentioned, in order to ensure good optical performance virtually without effects of the birefringence of fluorite in the projection optical system, it is important to control an angle difference between the optical axis and predetermined crystal axis (crystal axis [111], [100] or [110]) of the fluorite lens to a predetermined allowable amount or less. Accordingly, in the present invention, the angle difference is set at 1° or less between the optical axis and the predetermined crystal axis such as the crystal axis [111], [100] or [110] in a light-transmissive crystal member formed of a crystal material belonging to the cubic system, such as fluorite.

As a result of this, as numerically verified in each of the embodiments to be described later, good optical performance can be ensured virtually without effects of the birefringence of the fluorite by setting the angle difference at 1° or less between the optical axis and predetermined crystal axis of the fluorite lens used as the light-transmissive crystal member. Note that, in order to ensure good optical performance virtually without effects of the birefringence of the fluorite, it is necessary to set an angle difference at 1° or less at least between two light-transmissive crystal members included in the projection optical system, and it is preferable to set angle differences at 2° or less among all of the light-transmissive crystal members included in the projection optical system.

Moreover, as numerically verified in each of the embodiments to be described later, in a projection optical system with a relatively high numerical aperture, an angle difference between light beams transmitting through a lens element arranged in the vicinity of an image surface is large in the lens. Moreover, even though the optical axis [111] or [100] with mall birefringence is selected as a predetermined crystal axis to coincide with the optical axis, light beams greatly affected by the birefringence exist in a transmitted light beam. Therefore, in the lens element arranged in the vicinity of the image surface, it will be particularly important to have the predetermined crystal axis coincided with the optical axis of the lens as designed. In other words, in order to reduce the effects of birefringence efficiently, it is particularly preferable to set the angle difference at 1° or less between the predetermined crystal axis and the optical axis in a light-transmissive crystal member arranged closest to the image surface (second surface) Moreover, in the case of a catadioptric projection optical system, a lens element is usually arranged in the vicinity of a concave reflective mirror to correct a chromatic aberration and a curvature of field. However, an angle difference between light beams transmitting through the lens element is large in the lens, and light beams greatly affected by the birefringence exist in the transmitted light beam. Moreover, these light beams travel bidirectionally through a bidirectional optical path formed by the concave reflective mirror. Therefore, for the lens element arranged in the bidirectional optical path formed by the concave reflective mirror, it is particularly important to have the predetermined crystal axis coincided with the optical axis of the lens as designed. In other words, in order to reduce the effects of birefringence efficiently, it is preferable to set the angle difference at 1° or less between the predetermined crystal axis and the optical axis especially for the light-transmissive crystal member arranged in the vicinity of the concave reflective mirror.

Furthermore, in the case of a catadioptric and image re-forming projection optical system for forming an intermediate image between an object surface and an image surface, the angle difference of the light beams transmitting through the lens element arranged in the vicinity of the concave reflective mirror becomes prominent in the lens due to the intensification of power of the concave reflective mirror, and the light beams greatly affected by the birefringence exist in the transmitted light beam. Therefore, for the lens element arranged in the vicinity of the concave reflective mirror, it is important to have the predetermined crystal axis in particular coincided with the optical axis of the lens as designed. In other words, in the case of the catadioptric and image re-forming projection optical system, it is preferable to set the angle difference at 1° or less between the predetermined crystal axis and the optical axis in the light-transmissive crystal member arranged in the vicinity of the concave reflective mirror.

Moreover, also in the case of a catadioptric and three-time image-forming projection optical system for forming two intermediate images between an object surface and an image surface, a light-transmissive crystal member arranged in the optical path of the second image-forming optical system, where the concave reflective mirror is arranged, is particularly prone to be affected by the birefringence. Therefore, it is preferable to set the angle difference at 1° or less between the predetermined crystal axis and the optical axis. In addition, for example, assuming that all the lens elements constituting the projection optical system are formed of fluorite, approximately 15% of all the lens elements significantly affect the in-surface line width error ΔCD. Accordingly, it is preferable to set the angle difference at 1° or less between the predetermined crystal axis and the optical axis for more than or equal to 15% of all the light-transmissive crystal members included in the projection optical system.

Moreover, as mentioned previously, it is important to control the relatively rotational angle difference between the pair of fluorite lenses around the optical axis thereof to a predetermined allowable amount or less in order to ensure good optical performance virtually without effects of the birefringence in the projection optical system. Accordingly, in the present invention, an angle difference of a relatively rotational angle around the optical axis is set at 1° or less between predetermined crystal axes (crystal axes orthogonal to the crystal axis [111], [100] or [110]) in the pair of light-transmissive crystal members from the predetermined value (60°, 45° or 90°). Consequently, good optical performance can be ensured virtually without effects of the birefringence of fluorite by setting the relatively rotational angle difference at 1° or less between the pair of fluorite lenses around the optical axis.

Furthermore, as mentioned previously, there is a possibility that an area having an abnormal difference between orientations of the crystal axes exists locally in the fluorite crystal. Accordingly, it is important to control the relative angle difference between the orientations of the crystal axes in the abnormal fluorite crystal to the predetermined allowable amount or less in order to ensure good optical performance virtually without effects of the birefringence in the projection optical system. Accordingly, in the present invention, when a region having the difference between the orientations of the crystal axes exists in at least two light-transmissive crystal members formed of a crystal material belonging to the cubic system such as fluorite, such a relative angle difference is set at 2° or less.

As a result, good optical performance can be ensured virtually without effects of the birefringence of fluorite, for example, by controlling the relative angle difference between the orientations of the crystal axes to 2° or less in the abnormal fluorite crystal used to form the fluorite lenses for light-transmissive crystal members. Similar to the case of a relative angle difference between the predetermined crystal axis and the optical axis, in the case of the relative angle difference between the orientations of the crystal axes, in order to reduce the effects of birefringence efficiently, it is preferable to set the relative angle difference between the orientations of the crystal axes at 2° or less particularly in the light-transmissive crystal member arranged closest to the image surface (second surface) and the light-transmissive crystal member arranged in the vicinity of the concave reflective mirror.

Similarly, in the case of the catadioptric and image re-forming projection optical system, it is preferable to set the relative angle difference at 2° or less between the orientations of the crystal axes in the light-transmissive crystal member arranged in the vicinity of the concave reflective mirror in order to reduce the effects of birefringence efficiently Moreover, in the case of the catadioptric and three-time imaging projection optical system for forming two intermediate images between the object surface and the image surface, in order to reduce the effects of birefringence efficiently, it is preferable to set the relative angle difference at 2° or less between the orientations of the crystal axes in the light-transmissive crystal member arranged in the optical path of the second image-forming optical system where the concave reflective mirror is arranged. Furthermore, in order to reduce the effects of birefringence efficiently, it is preferable to set the relative angle difference at 2° or less between the orientations of the crystal axes in all of the light-transmissive crystal members included in the projection optical system.

Note that, in the present invention, the in-surface line width error ΔCD in the case of projecting and exposing thin lines of a gate pattern or the like by using a phase shift reticle affected most significantly by the birefringence at present is used as an index when determining the allowable value of the angle difference between the predetermined crystal axis and the optical axis in the light-transmissive crystal member, the allowable value of the angle difference of the relatively rotational angle between the predetermined crystal axes in the pair of light-transmissive crystal members around the optical axis from the predetermined value, and the allowable value of the relative angle difference between the orientations of the crystal axes in the light-transmissive crystal member. The line width error can be controlled to 2% or less of a resolved line width by satisfying the above-described allowable values in the present invention. Supposing further progress of a super resolution technology and enlargement of the NA of the projection optical system, it is desirable that each of the allowable values should be reduced to approximately 70%.

The embodiments of the present invention will be described based on the accompanying drawings.

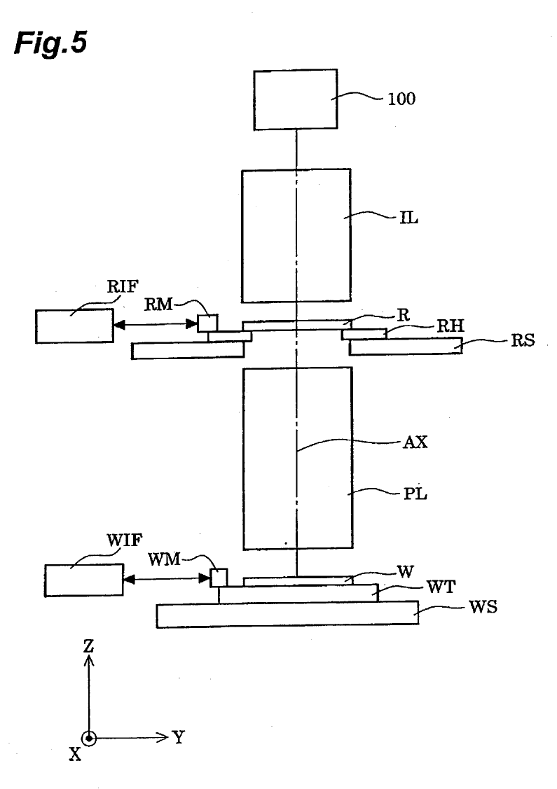

FIG. 5 is a diagram schematically illustrating a constitution of an exposure apparatus having a projection optical system according to the embodiments of the present invention. Note that, in FIG. 5, the Z axis is set in parallel to the reference optical axis AX of the projection optical system PL, the Y axis is set in parallel to the sheet surface of FIG. 5 on a surface vertical to the reference optical axis AX, and the X axis is set vertically to the sheet surface of FIG. 5.

The illustrated exposure apparatus is provided with, for example, a F₂ laser light source used (center wavelength of oscillation: 157.6244 nm) as the light source 100 for supplying illumination light in the ultraviolet range. Light emitted from the light source 100 evenly illuminates the reticle R on which a predetermined pattern is formed through the illumination optical system IL. Note that an optical path between the light source 100 and the illumination optical system IL is hermetically sealed by a casing (not shown), and a casing from the light source 100 to an optical member closest to the reticle in the illumination optical system IL is filled with an inert gas having low absorptivity of exposure light, such as helium gas and nitrogen, or is maintained in a virtually vacuum state.

The reticle R is held in parallel to the XY plane on the reticle stage RS by the reticle holder RH. The pattern to be transferred is formed on the reticle R, and, among the entire pattern area, a rectangular (slit-shaped) pattern area that has long sides along the X direction and short sides along the Y direction is illuminated. The reticle stage RS is constituted in such a manner that it is two-dimensionally movable along the reticle surface (i.e., XY plane) by an operation of an unillustrated drive system and that position coordinates thereof are measured and controlled in position by the interference meter RIF using the reticle-moving mirror RM.

Light from the pattern formed on the reticle R forms a reticle pattern image on the wafer W, a photosensitive substrate, through the catadioptric projection optical system PL. The wafer W is maintained in parallel to the XY plane on the wafer stage WS by the wafer table (wafer holder) WT. A pattern image is formed on a rectangular exposure area that has long sides along the X direction and short sides along the Y direction so as to optically correspond to the rectangular illuminated area on the reticle R. The wafer stage WS is constituted in such a manner that it is two-dimensionally movable along the wafer surface (i.e., XY plane) by an operation of an unillustrated drive system and that position coordinates thereof are measured and controlled in position by the interference meter WIF using the wafer-moving mirror WM.

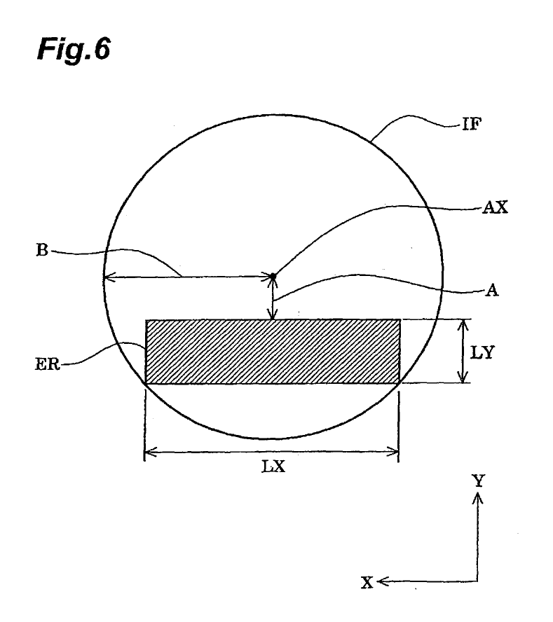

FIG. 6 is a diagram illustrating a positional relationship between the rectangular exposure area (i.e., effective exposure area) formed on the wafer and a reference optical axis. In each of the embodiments, as illustrated in FIG. 6, the rectangular effective exposure area ER having a desired size is set at a position with an interval of the off-axis A in the −Y direction from the reference optical axis AX on the circular area (image circle) IF having the radius B with the reference optical axis AX regarded as a center. Here, the length of the effective exposure area ER in the X direction is denoted by LX, and the length thereof in the Y direction is denoted by LY.

In other words, in each of the embodiments, the rectangular effective exposure area ER having a desired size is set at the position with the distance of the off-axis A (the off-axial amount A) in the −Y direction from the reference optical axis AX, and the radius B of the circular image circle IF is defined around the reference optical axis AX as a center so as to include the effective exposure area ER. Accordingly, though not being illustrated, to correspond to the effective exposure area ER, a rectangular illumination area having a size and a shape, which correspond to those of the effective exposure area ER, (i.e., effective illumination area) is formed at the position at the distance of the off-axis A in the −Y direction from the reference optical axis AX on the reticle R.

Moreover, the illustrated exposure apparatus is constituted such that the inside of the projection optical system PL keeps a hermetically sealed state between an optical member arranged closest to the reticle (lens L11 in each of the embodiments) and an optical member arranged closest to the wafer (lens L313 in each of the embodiments) among optical members constituting the projection optical system PL. Then, a casing inside the projection optical system PL is filled with an inert gas such as helium gas and nitrogen, or the inside casing is virtually maintained in a vacuum state.

Furthermore, in an arrow optical path between the illumination optical system IL and the projection optical system PL, the reticle R, the reticle stage RS and the like are arranged, and the inside space of a casing (not shown) that hermetically surrounds the reticle R, the reticle stage RS and the like is filled with the inert gas such as nitrogen and helium gas or is virtually maintained in a vacuum state.

Moreover, in a narrow optical path between the projection optical system PL and the wafer W, the wafer W, the wafer stage WS and the like are arranged, and the inside space of a casing (not shown) that hermetically surrounds the wafer W, the wafer stage WS and the like is filled with the inert gas such as nitrogen and helium gas or is virtually maintained n a vacuum state. Thus, an atmosphere, where the exposure light is hardly absorbed, is formed over the entire optical path from the light source 100 to the wafer W.

As described above, the illumination area on the reticle R and the exposure area on the wafer W (i.e., effective exposure area ER), which are defined by the projection optical system PL, are rectangles having short sides along the Y direction. Accordingly, while controlling the positions of the reticle R and wafer W by use of the drive systems and the interference meters (RIF, WIF), the reticle stage RS and the wafer stage WS and thus the reticle R and the wafer W are synchronously moved (scanned) along the direction of the short sides of the rectangular exposure and illumination areas, that is, the Y direction in the same direction (i.e., the same orientation). Thus, on the wafer W, a reticle pattern is scanned and exposed for an area that has a width equal to that of the long sides of the exposure area and a length that corresponds to a scanned amount (moved amount) of the wafer W.

In each of the embodiments, the projection optical system PL includes the first image-forming optical system G1 that is refractive (dioptric) and is for forming the first intermediate image of the pattern of the reticle R arranged on the first surface, the second image-forming optical system G2 that is c posed of the concave reflective mirror CM and two negative lenses and is for forming the second intermediate image virtually equal to the first intermediate image in size (virtually equal to the first intermediate image in size, which is the secondary image of the reticle pattern), and the third image-forming optical system G3 that is refractive (dioptric) and is for forming the final image of the reticle pattern (reduced image of the reticle pattern) on the wafer W arranged on the second surface based on the light from the second intermediate image.

Note that, in each of the embodiments, the first optical path-bending mirror (first folding mirror) M1 for deflecting the light from the first image-forming optical system G1 toward the second image-forming optical system G2 is arranged in the vicinity of the forming position of the first intermediate image in the optical path between the first image-forming optical system G1 and the second image-forming optical system G2. Moreover, the second optical path-bending mirror (second folding mirror) M2 for deflecting the light from the second image-forming optical system G2 toward the third image-forming optical system G3 is arranged in the vicinity of the forming position of the second intermediate image in the optical path between the second image-forming optical system G2 and the third image-forming optical system G3.

Moreover, in each of the embodiments, the first image-forming optical system G1 has the optical axis AX1 extended linearly, the third image-forming optical system G3 has the optical axis AX3 extended linearly, and the optical axes AX1 and AX3 are set to coincide with the reference optical axis AX that is a single optical axis shared by the optical axes AX1 and AX3. Note that the reference optical axis AX is positioned along the gravity direction (i.e., vertical direction). Consequently, the reticle R and the wafer W are arranged in parallel to each other along surfaces orthogonal to the gravity direction, that is, the horizontal planes. In addition, all of the lenses constituting the first image-forming optical system G1 and all of the lenses constituting the third image-forming optical system G3 are also arranged along the horizontal planes on the reference optical axis AX.

Meanwhile, the second image-forming optical system G2 has the optical axis AX2 extended linearly, and the optical axis AX2 is set to be orthogonal to the reference optical axis AX. Furthermore, both of the first and second optical path-bending mirrors M1 and M2 have flat reflective surfaces, and are unified and composed as one optical briber (one optical path-bending mirror) having two reflective surfaces. An intersecting lines of these two reflective surfaces (precisely, intersecting lines of virtual extended surfaces thereof) is set to intersect with the AX1 of the first image-forming optical system G1, the AX2 of the second image-forming optical system G2 and the AX3 of the third image-forming optical system G3 at one point. In each of the embodiments, both of the first and second optical path-bending mirrors M2 and M2 are composed as surface reflective mirrors.

In each of the embodiments, fluorite (crystals of CaF₂) is used for all of the refractive optical members (lens elements) constituting the projection optical system PL. Moreover, the center wavelength of oscillation of F₂ laser light, which is exposure light, is 157.6244 nm, and the refractive index of CaF₂ in the vicinity of the wavelength of 157.6244 nm is changed with a ratio of −2.6×10⁻⁶ per wavelength change of +1 pm, and is changed with a ratio of +2.6×10⁻⁶ per wavelength change of −1 pm. In other words, in the vicinity of the wavelength of 157.6244 nm, dispersion of the refractive index of CaF₂ (dn/dλ) is 2.6×10⁻⁶/pm.

Accordingly, in each of the embodiments, the refractive index of CaF₂ with respect to the center wavelength of 157.6244 nm is 1.55930666, the refractive index of CaF₂ with respect to the wavelength of 157.6254 nm (=157.6244 nm+1 pm) is 1.55930406, and the refractive index of CaF₂ with respect to the wavelength of 157.6234 nm (=157.6244 nm−1 pm) is 1.55930926.

Moreover, in each of the embodiments, an aspheric surface is represented by the following equation (a) where a height in the vertical direction of the optical axis is y, a distance (sag amount) along the optical axis from a tangential plane at the vertex of the aspheric surface to a position on the aspheric surface at the height y is z, a curvature radius of the vertex is r, a conic coefficient is x, and an n-ary aspheric coefficient is Cn. In each of the embodiments, reference symbols * are added to the right sides of surface numbers on lens surfaces formed to be aspheric.

$$[ Equation 1 ] \\ z = ( {y}^{2} / r ) / [ 1 + {\{ 1 - ( 1 + κ ) \cdot {y}^{2} / {r}^{2} \}}^{1 / 2} ] + {C}_{4} \cdot {y}^{4} + {C}_{6} \cdot {y}^{6} + {C}_{8} \cdot {y}^{8} + {C}_{10} \cdot {y}^{ 10} + {C}_{12} \cdot {y}^{12} + {C}_{14} \cdot {y}^{14} \qquad ( a )$$

[First Embodiment]

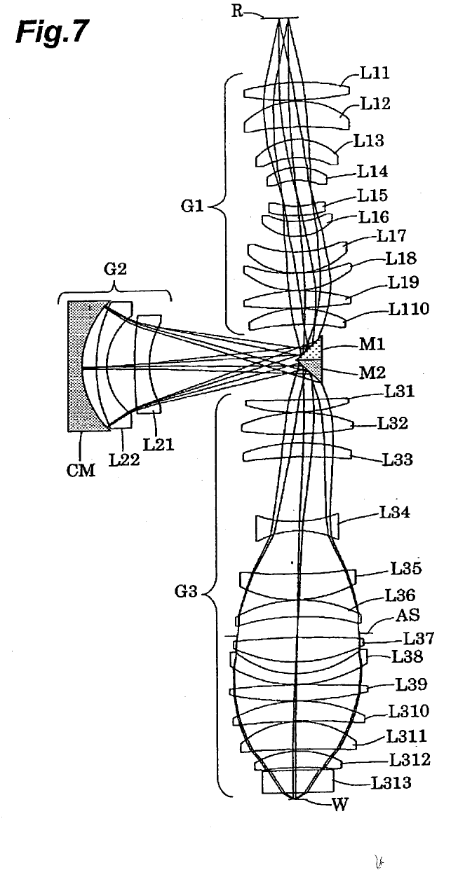

FIG. 7 is a diagram illustrating a constitution of lenses of a projection optical system according to a first embodiment of the present embodiments. Referring to FIG. 7, in the projection optical system PL according to the first embodiment, the first image-forming optical system G1 is composed of, in order from the reticle side, the biconvex lens L11, the positive meniscus lens L12 orienting its aspheric concave surface to the wafer side, the positive meniscus lens L13 orienting its convex surface to the reticle side, the positive meniscus lens L14 orienting its convex surface to the reticle side, the negative meniscus lens L15 orienting its concave surface to the reticle side, the positive meniscus lens L16 orienting its concave surface to the reticle side, the positive meniscus lens L17 orienting its aspheric concave surface to the reticle side, the positive meniscus lens L18 orienting its concave surface to the reticle side, the biconvex lens L19, and the positive meniscus lens L10 orienting its aspheric concave surface to the wafer side.

Moreover, the second image-forming optical system G2 is composed of the negative meniscus lens L21 orienting its aspheric convex surface to the reticle side, the negative meniscus lens L22 orienting its concave surface to the reticle side, and the concave reflective mirror CM in order from the reticle side along the light traveling path (i.e., incident side).

Furthermore, the third image-forming optical system G3 is composed of, in order from the reticle side along the light traveling direction, the positive meniscus lens L31 orienting its concave surface to the reticle side, the biconvex lens L32, the positive meniscus lens L33 orienting its aspheric concave surface to the wafer side, the biconcave lens L34, the positive meniscus lens L35 orienting its aspheric concave surface to the reticle side, the positive meniscus lens L36 orienting its aspheric concave surface to the wafer side, the aperture stop As, the biconvex lens L37, the negative meniscus lens L38 orienting its concave surface to the reticle side, the biconvex lens L39, the positive meniscus lens L310 orienting its convex surface to the reticle side, the positive meniscus lens L311 orienting its aspheric concave surface to the wafer side, the positive meniscus lens L312 orienting its convex surface to the reticle side, and the plano-convex lens L313 orienting its plane to the wafer side.

In the following Table (1), specification values of the projection optical system PL according to the first embodiment will be listed. In Table (1), the reference symbol λ denotes a center wavelength of exposure light, the reference symbol β denotes a projection magnification (image-forming magnification of the entire system), the reference symbol NA denotes a numerical aperture on the image side (wafer side), the reference symbol B denotes a radius of the image circle IF on the wafer W, the reference symbol A denotes an off-axis of the effective exposure area ER, the reference symbol LX denotes a dimension along the X direction of the effective exposure area ER (dimension of the long sides), and the reference symbol LY denotes a dimension along the Y direction of the effective exposure area ER (dimension of the short sides), respectively.

Moreover, the surface number represents the surfaces in order from the reticle side along the traveling direction of a light beam from the reticle surface, which is the object surface (first surface) , to the wafer surface, which is the image surface (second surface). The reference symbol r represents the curvature radii of the respective surfaces (vertex curvature radius in the case of an aspheric surface: m). The reference symbol d represents the on-axis intervals between the respective surfaces, that is, the surface intervals (mm). The reference symbol (C·D) represents the crystal axes C coinciding with the optical axes and the angle positions D of the other specific crystal axes in the respective fluorite lenses. The reference symbol ED represents the effective diameters (clear apertures) of the respective surfaces (mm). The reference symbol n denotes the refractive indices with respect to the center wavelength.

Note that, with regard to the surface intervals d, signs thereof are defined to be changed each time when light is reflected thereon. Accordingly, the signs of the surface intervals d are set negative in the optical paths from the reflective surface of the first optical path-bending mirror M1 to the concave reflective mirror CM and in the optical path from the reflective surface of the second optical path-bending mirror M2 to the image surface, and the signs are set positive in the other optical paths. Then, in the first image-forming optical system G1, curvature radii of convex surfaces toward the reticle side are set positive, and curvature radii of concave surfaces toward the reticle side are set negative. Meanwhile, in the third image-forming optical system G3, curvature radii of concave surfaces toward the reticle side are set positive, and curvature radii of toward the reticle side convex surfaces are set negative. Furthermore, in the second image-forming optical system G2, curvature radii of concave surfaces toward the reticle side (that is, incident side) along the light traveling path are set positive, and curvature radii of convex surfaces are set negative.

Moreover, each angle position D is, for example, an angle of the crystal axis [−111] with respect to a reference orientation when the crystal axis C is the crystal axis [111], and is for example, an angle of the crystal axis [010] with respect to a reference orientation when the optical axis C is the crystal axis [100]. Here, the reference orientation is defined to optically correspond to an orientation that is arbitrarily set, for example, to pass through the optical axis AX1 on the reticle surface. Specifically, in the case of setting the reference orientation in the +Y direction on the reticle surface, a reference orientation in the first image-forming optical system G1 is the +Y direction, a reference orientation in the second image-forming optical system G2 is the +Z direction (direction optically corresponding to the +Y direction on the reticle surface), and a reference orientation in the third image-forming optical system G3 is the −Y direction (direction optically corresponding to the +Y direction on the reticle surface).

Accordingly, (C·D)=(100·0) indicates that, for example, in a fluorite lens in which the optical axis and the crystal axis [100] coincide, the crystal axis thereof [010] is arranged along the reference orientation. Moreover, (C·D)=(100·45) indicates that, in the fluorite lens in which the optical axis and the crystal axis [100] coincide, the crystal axis [010] forms an angle of 45° with respect to the reference orientation. Specifically, the fluorite lenses of (C·D)=(100·0) and (C·D)=(100·45) constitute a pair of lenses having the crystal axis [100].

Moreover, (C·D)=(100·45) indicates that, for example, in a fluorite lens in which the optical axis and the crystal axis [111] coincide, a crystal axis thereof [−111] is arranged along the reference orientation. Moreover, (C·D)=(111·60) indicates that, in the fluorite lens in which the optical axis and the crystal axis [111] coincide, the crystal axis [−111] forms an angle of 60° with respect to the reference orientation. Specifically, the fluorite lenses of (C·D)=(111·0) and (C·D)=(111·60) constitute a pair of lenses having the optical axis [111].

Note that, in the above explanation of the angle positions D, it is not necessary that the setting of the reference orientation is shared by all the lenses, and for example, it is satisfactory if the setting is shared by a unit of each pair of lenses. Moreover, the specific crystal axis to be measured for an angle with respect to the reference orientation is not limited to the crystal axis [010] in the case of the pair of lenses having the crystal axis [100], or to the crystal axis [−111] in the case of the pair of lenses having the crystal axis [111], and for example, can be appropriately set in a unit of each pair of lenses. Note that Table (1) and Table (2) described later share the same notation.

TABLE 1
(Principal Specifications)

| | |
|---|---|
| λ = | 157.6244 nm |
| β = | −0.25 |
| NA = | 0.85 |
| B = | 14.4 mm |
| A = | 3 mm |
| LX = | 25 mm |
| LY = | 4 mm |

(Specifications of Optical Members)

| Sur- | | | | | | |
|---|---|---|---|---|---|---|
| face | | | | | | |
| num- | | | | | | |
| ber | r | d | (C · D) | ED | n | |
| | (Reticle | 103.3533 | | | | |
| | surface) | | | | | |
| 1 | 374.9539 | 27.7555 | (100 · 45) | 163.8 | 1.559307 | (L11) |
| 2 | −511.3218 | 2.0000 | | 165.0 | | |
| 3 | 129.8511 | 41.0924 | (100 · 0) | 164.3 | 1.559307 | (L12) |
| 4* | 611.8828 | 20.1917 | | 154.3 | | |
| 5 | 93.6033 | 29.7405 | (100 · 45) | 128.2 | 1.559307 | (L13) |
| 6 | 121.8341 | 16.0140 | | 110.0 | | |
| 7 | 83.6739 | 21.7064 | (111 · 0) | 92.3 | 1.559307 | (L14) |
| 8 | 86.7924 | 42.9146 | | 73.8 | | |
| 9 | −112.0225 | 15.4381 | (100 · 0) | 71.1 | 1.559307 | (L15) |
| 10 | −183.1783 | 9.7278 | | 86.8 | | |
| 11 | −103.9725 | 24.6160 | (111 · 0) | 92.2 | 1.559307 | (L16) |
| 12 | −79.4102 | 26.3046 | | 108.7 | | |
| 13* | −166.4447 | 35.1025 | (111 · 60) | 137.8 | 1.559307 | (L17) |
| 14 | −112.7566 | 1.0007 | | 154.4 | | |
| 15 | −230.1701 | 28.4723 | (111 · 60) | 161.5 | 1.559307 | (L18) |
| 16 | −132.8952 | 1.0000 | | 168.4 | | |
| 17 | 268.5193 | 29.4927 | (100 · 45) | 167.1 | 1.559307 | (L19) |
| 18 | −678.1883 | 1.0000 | | 164.3 | | |
| 19 | 155.2435 | 26.5993 | (100 · 45) | 150.3 | 1.559307 | (L110) |
| 20* | 454.2151 | 61.5885 | | 139.9 | | |
| 21 | ∞ | −238.9300 | | | | (M1) |
| 22* | 140.0521 | −22.7399 | (111 · 60) | 124.5 | 1.559307 | (L21) |
| 23 | 760.9298 | −44.1777 | | 146.1 | | |
| 24 | 109.3587 | −16.0831 | (111 · 0) | 159.6 | 1.559307 | (L22) |
| 25 | 269.5002 | −22.7995 | | 207.8 | | |
| 26 | 159.8269 | 22.7995 | | 213.7 | | (CM) |
| 27 | 269.5002 | 16.0831 | (111 · 0) | 209.4 | 1.559307 | (L22) |
| 28 | 109.3587 | 44.1777 | | 168.2 | | |
| 29 | 760.9298 | 22.7399 | (111 · 60) | 162.0 | 1.559307 | (L21) |
| 30* | 140.0521 | 238.9300 | | 143.2 | | |
| 31 | ∞ | −67.1481 | | | | (M2) |
| 32 | 2064.4076 | −20.4539 | (100 · 0) | 154.9 | 1.559307 | (L31) |
| 33 | 264.1465 | −1.1114 | | 160.0 | | |
| 34 | −236.9696 | −36.6315 | (111 · 0) | 174.4 | 1.559307 | (L32) |
| 35 | 548.0272 | −14.7708 | | 174.4 | | |
| 36 | −261.5738 | −23.7365 | (111 · 60) | 167.9 | 1.559307 | (L33) |
| 37* | −844.5946 | −108.7700 | | 162.5 | | |
| 38 | 192.9421 | −16.1495 | (111 · 0) | 127.7 | 1.559307 | (L34) |
| 39 | −139.0423 | −71.8678 | | 128.7 | | |
| 40* | 1250.0000 | −43.1622 | (100 · 45) | 165.7 | 1.559307 | (L35) |
| 41 | 185.8787 | −1.0000 | | 180.1 | | |
| 42 | −206.0962 | −27.6761 | (111 · 0) | 195.0 | 1.559307 | (L36) |
| 43* | −429.3688 | −30.3562 | | 191.8 | | |
| 44 | ∞ | −4.0000 | | 196.8 | | (AS) |
| 45 | −1246.9477 | −40.5346 | 111 · 60) | 199.6 | 1.559307 | (L37) |
| 46 | 229.5046 | −19.2328 | | 202.5 | | |
| 47 | 153.1781 | −18.0000 | (100 · 0) | 201.4 | 1.559307 | (L38) |
| 48 | 200.0000 | −1.0000 | | 213.1 | | |
| 49 | −1605.7826 | −25.8430 | (111 · 0) | 215.0 | 1.559307 | (L39) |
| 50 | 497.7325 | −1.0000 | | 214.9 | | |
| 51 | −232.1186 | −31.8757 | (111 · 0) | 204.9 | 1.559307 | (L310) |
| 52 | −993.7015 | −1.0000 | | 198.1 | | |
| 53 | −142.9632 | −44.5398 | (100 · 45) | 178.7 | 1.559307 | (L311) |
| 54* | −3039.5137 | −3.0947 | | 162.7 | | |
| 55 | −139.2455 | −27.2564 | (111 · 60) | 134.5 | 1.559307 | (L312) |
| 56 | −553.1425 | −4.2798 | | 116.2 | | |
| 57 | −1957.7823 | −37.0461 | (100 · 0) | 110.3 | 1.559307 | (L313) |
| 58 | ∞ | −11.0000 | | 63.6 | | |
| | (Wafer | | | | | |
| | surface) | | | | | |

(Aspheric surface data)
4th surface

| | |
|---|---|
| κ = 0 | |
| C₄ = 4.21666 × 10⁻⁸ | C₆ = −1.01888 × 10⁻¹² |
| C₈ = 5.29072 × 10⁻¹⁷ | C₁₀ = −3.39570 × 10⁻²¹ |
| C₁₂ = 1.32134 × 10⁻²⁶ | C₁₄ = 7.93780 × 10⁻³⁰ |

13th surface

| | |
|---|---|
| κ = 0 | |
| C₄ = 4.18420 × 10⁻⁸ | C₆ = −4.00795 × 10⁻¹² |
| C₈ = −2.47055 × 10⁻¹⁶ | C₁₀ = 4.90976 × 10⁻²⁰ |
| C₁₂ = −3.51046 × 10⁻²⁴ | C₁₄ = 1.02968 × 10⁻²⁸ |

20th surface

| | |
|---|---|
| κ = 0 | |
| C₄ = 6.37212 × 10⁻⁸ | C₆ = −1.22343 × 10⁻¹² |
| C₈ = 3.90077 × 10⁻¹⁷ | C₁₀ = 2.04618 × 10⁻²¹ |
| C₁₂ = −5.11335 × 10⁻²⁵ | C₁₄ = 3.76884 × 10⁻²⁹ |

22nd surface and 30th surface (identical surfaces)

| | |
|---|---|
| κ = 0 | |
| C₄ = −6.69423 × 10⁻⁶ | C₆ = −1.77134 × 10⁻¹⁴ |
| C₈ = 2.85906 × 10⁻¹⁷ | C₁₀ = 8.86068 × 10⁻²¹ |
| C₁₂ = 1.42191 × 10⁻²⁶ | C₁₄ = 6.35242 × 10⁻²⁹ |

37th surface

| | |
|---|---|
| κ = 0 | |
| C₄ = −2.34854 × 10⁻⁸ | C₆ = −3.60542 × 10⁻¹³ |
| C₈ = −1.45752 × 10⁻¹⁷ | C₁₀ = −1.33699 × 10⁻²¹ |
| C₁₂ = 1.94350 × 10⁻²⁶ | C₁₄ = −1.21690 × 10⁻²⁹ |

40th surface

| | |
|---|---|
| κ = 0 | |
| C₄ = 5.39302 × 10⁻⁸ | C₆ = −7.58468 × 10⁻¹³ |
| C₈ = −1.47196 × 10⁻¹⁷ | C₁₀ = −1.32017 × 10⁻²¹ |
| C₁₂ = 0 | C₁₄ = 0 |

43rd surface

| | |
|---|---|
| κ = 0 | |
| C₄ = −2.36659 × 10⁻⁸ | C₆ = −4.34705 × 10⁻¹³ |
| C₈ = 2.16318 × 10⁻¹⁸ | C₁₀ = 9.11326 × 10⁻²² |
| C₁₂ = −1.95020 × 10⁻²⁶ | C₁₄ = 0 |

54th surface

| | |
|---|---|
| κ = 0 | |
| C₄ = −3.78066 × 10⁻⁸ | C₆ = −3.03038 × 10⁻¹³ |
| C₈ = 3.38936 × 10⁻¹⁷ | C₁₀ = −6.41494 × 10⁻²¹ |
| C₁₂ = 4.14101 × 10⁻²⁵ | C₁₄ = −1.40129 × 10⁻²⁹ |

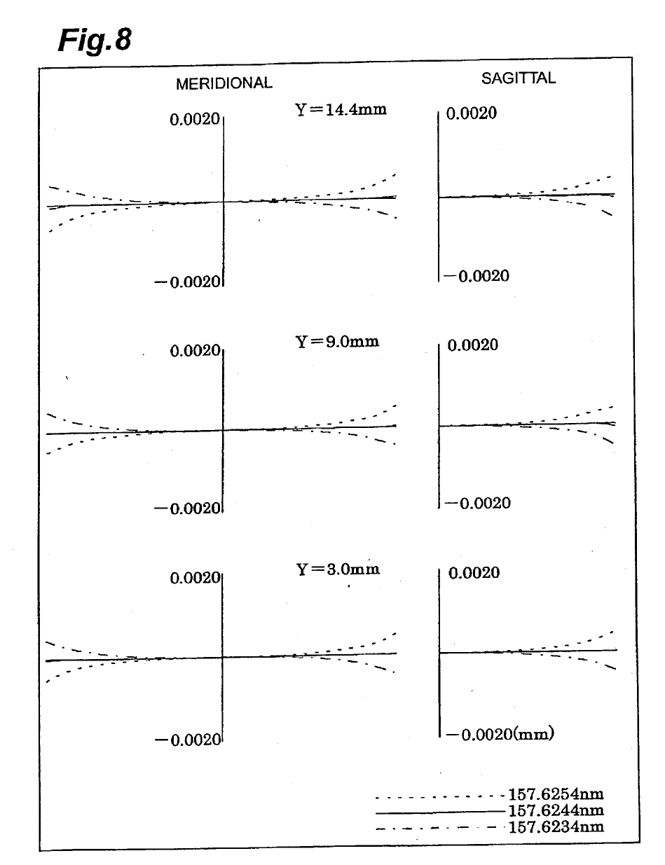

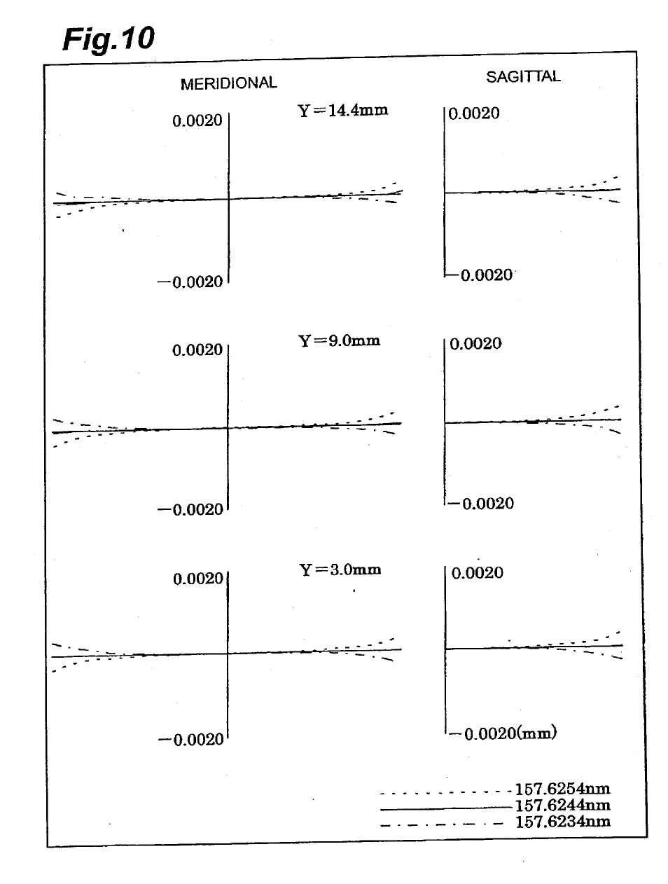

FIG. 8 shows diagrams illustrating transverse aberrations in the first embodiment. In the aberration diagrams, the reference symbol Y represents image heights, the solid lines represent the center wavelength of 157.6244 nm, the broken lines represent the wavelength of 157.6254 (=157.6244 nm+1 pm), and the alternate long and short dash lines represent the wavelength of 157.6234 (=157.6244 nm−1 pm). Note that FIG. 8 and FIG. 10 described later share the same notation. As clearly shown from the aberration diagrams in FIG. 8, in the first embodiment, chromatic aberrations suitably are corrected for the exposure light with the wavelength width of 157.6244 nm+1 pm though relatively large image-side numerical aperture (NA=0.85) and projection field (effective diameter=28.8 mm) are secured.

[Second Embodiment]

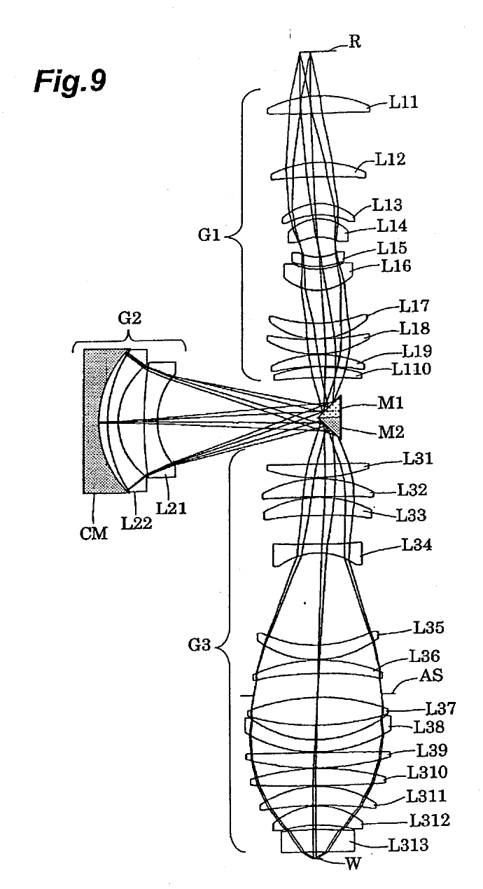

FIG. 9 is a diagram illustrating a constitution of lenses of a projection optical system according to a second embodiment of the present embodiments. Referring to FIG. 9, in the projection optical system PL according to the second embodiment, the first image-forming optical system G1 is composed of, in order from the reticle side, the biconvex lens L11, the positive meniscus lens L12 orienting its aspheric concave surface to the wafer side, the positive meniscus lens L13 orienting its convex surface to the reticle side, the positive meniscus lens L14 orienting its convex surface to the reticle side, the negative meniscus lens L15 orienting its concave surface to the reticle side, the positive meniscus lens L16 orienting its concave surface to the reticle side, the positive meniscus lens L17 orienting its aspheric concave surface to the reticle side, the positive meniscus lens L18 orienting its concave surface to the reticle side, the positive meniscus lens L19 orienting its convex surface to the reticle side, and the positive meniscus lens L110 orienting its aspheric concave surface to the wafer side.

Moreover, the second image-forming optical system G2 is composed of, in order from the reticle side (i.e., incident side) along the light traveling path, the negative meniscus lens L21 orienting its aspheric convex surface to the wafer side (i.e., exit side), the negative meniscus lens L22 orienting its concave side to the reticle side, and the concave reflective mirror CM Furthermore, the third image-forming optical system G3 is composed of, in order from the reticle side along the light traveling direction, the positive meniscus lens L31 orienting its concave surface to the reticle side, the positive meniscus lens L32 orienting its convex surface to the reticle side, the positive meniscus lens L33 orienting its aspheric concave surface to the wafer side, the biconcave lens L34, the positive meniscus lens L35 orienting its aspheric concave surface to the reticle side, the positive meniscus lens L36 orienting its aspheric concave surface to the wafer side, the aperture stop AS, the biconvex lens L37, the negative meniscus lens L38 orienting its concave surface to the reticle side, the plano-convex lens L39 orienting its plane to the reticle side, the biconvex lens L310, the positive meniscus lens L311 orienting its aspheric concave surface to the wafer side, the positive meniscus lens L312 orienting its convex surface to the reticle side, and the plano-convex lens L313 orienting its plane to the wafer side.

In the following Table (2), specification values of the projection optical system PL according to the second embodiment will be listed.

TABLE 2
(Principal Specifications)

| | |
|---|---|
| λ = | 157.6244 nm |
| β = | −0.25 |
| NA = | 0.85 |
| B = | 14.4 mm |
| A = | 3 mm |
| LX = | 25 mm |
| LY = | 4 mm |

(Specifications of Optical Members)

| Sur- | | | | | | |
|---|---|---|---|---|---|---|
| face | | | | | | |
| num- | | | | | | |
| ber | r | d | (C · D) | ED | n | |
| | (Reticle | 64.8428 | | | | |
| | surface) | | | | | |
| 1 | 183.9939 | 26.4947 | (100 · 45) | 150.2 | 1.559307 | (L11) |
| 2 | −3090.3604 | 74.3108 | | 149.6 | | |
| 3 | 168.6161 | 21.2848 | (100 · 45) | 138.4 | 1.559307 | (L12) |
| 4* | 630.6761 | 41.2206 | | 134.6 | | |
| 5 | 78.6721 | 17.8201 | (100 · 45) | 104.9 | 1.559307 | (L13) |
| 6 | 104.6154 | 6.3217 | | 96.2 | | |
| 7 | 61.9289 | 28.1473 | (111 · 0) | 86.0 | 1.559307 | (L14) |
| 8 | 71.5027 | 31.3308 | | 64.2 | | |
| 9 | −62.9418 | 14.1300 | (111 · 60) | 60.6 | 1.559307 | (L15) |
| 10 | −108.5396 | 4.2959 | | 74.5 | | |
| 11 | −87.0095 | 32.7581 | (100 · 0) | 76.6 | 1.559307 | (L16) |
| 12 | −74.4464 | 51.3253 | | 99.3 | | |
| 13* | −187.4766 | 24.0651 | (111 · 60) | 136.3 | 1.559307 | (L17) |
| 14 | −108.3982 | 1.0000 | | 142.6 | | |
| 15 | −377.3605 | 23.5413 | (111 · 60) | 145.7 | 1.559307 | (L18) |
| 16 | −140.1956 | 1.0164 | | 148.0 | | |
| 17 | 160.9494 | 18.0355 | (100 · 45) | 135.5 | 1.559307 | (L19) |
| 18 | 331.3044 | 1.0260 | | 130.4 | | |
| 19 | 201.2009 | 17.3139 | (111 · 60) | 127.3 | 1.559307 | (L110) |
| 20* | 1155.2346 | 61.5885 | | 121.3 | | |
| 21 | ∞ | −240.7562 | | | | (M1) |
| 22 | 116.6324 | −19.2385 | (111 · 60) | 137.5 | 1.559307 | (L21) |
| 23* | 765.4623 | −38.0668 | | 169.7 | | |
| 24 | 116.0122 | −16.0000 | (111 · 0) | 174.7 | 1.559307 | (L22) |
| 25 | 208.8611 | −16.2875 | | 217.3 | | |
| 26 | 159.0966 | 16.2875 | | 221.6 | | (CM) |
| 27 | 208.8611 | 16.0000 | (111 · 0) | 218.2 | 1.559307 | (L22) |
| 28 | 116.0112 | 38.0668 | | 178.5 | | |
| 29* | 765.4623 | 19.2385 | (111 · 60) | 176.3 | 1.559307 | (L21) |
| 30 | 116.6324 | 240.7562 | | 146.6 | | |
| 31 | ∞ | −73.9823 | | | | (M2) |
| 32 | 15952.4351 | −21.9279 | (100 · 90) | 141.9 | 1.559307 | (L31) |
| 33 | 221.6147 | −1.6265 | | 146.7 | | |
| 34 | −170.0000 | −28.2387 | (111 · 60) | 160.5 | 1.559307 | (L32) |
| 35 | −2153.8066 | −1.1124 | | 159.1 | | |
| 36 | −160.8559 | −28.5266 | (111 · 0) | 155.6 | 1.559307 | (L33) |
| 37* | −834.7245 | −45.2078 | | 148.5 | | |
| 38 | 1304.0831 | −14.2927 | (111 · 0) | 128.0 | 1.559307 | (L34) |
| 39 | −93.4135 | −146.1958 | | 117.0 | | |
| 40* | 175.1344 | −22.0000 | (100 · 45) | 165.4 | 1.559307 | (L35) |
| 41 | 145.1494 | −1.0000 | | 174.1 | | |
| 42 | −232.7162 | −21.0326 | (100 · 45) | 186.2 | 1.559307 | (L36) |
| 43* | −962.4639 | −32.8327 | | 184.5 | | |
| 44 | ∞ | −4.0000 | | 192.0 | | (AS) |
| 45 | −293.0118 | −42.6744 | (100 · 0) | 202.2 | 1.559307 | (L37) |
| 46 | 344.3350 | −21.8736 | | 202.3 | | |
| 47 | 162.4390 | −17.9036 | (111 · 60) | 201.6 | 1.559307 | (L38) |
| 48 | 206.7120 | −1.0000 | | 210.1 | | |
| 49 | ∞ | −23.2771 | (100 · 45) | 207.3 | 1.559307 | (L39) |
| 50 | 394.6389 | −1.0000 | | 206.7 | | |
| 51 | −364.5931 | −25.4575 | (100 · 0) | 195.0 | 1.559307 | (L310) |
| 52 | 1695.8753 | −1.0000 | | 190.6 | | |
| 53 | −151.9499 | −29.0060 | (111 · 60) | 166.5 | 1.559307 | (L311) |
| 54* | −800.0000 | −1.0000 | | 157.0 | | |
| 55 | −101.8836 | −29.0009 | (100 · 45) | 129.3 | 1.559307 | (L312) |
| 56 | −220.0926 | −6.7987 | | 109.7 | | |
| 57 | −637.4367 | −33.9854 | (100 · 0) | 104.6 | 1.559307 | (L313) |
| 58 | ∞ | −11.0000 | | 63.6 | | |
| | (Wafer | | | | | |
| | surface) | | | | | |

(Aspheric surface data)
4th surface

| | |
|---|---|
| κ = 0 | |
| C₄ = −5.82127 × 10⁻⁸ | C₆ = 7.43324 × 10⁻¹² |
| C₆ = 1.66683 × 10⁻¹⁶ | C₁₀ = −6.92313 × 10⁻²⁰ |
| C₁₂ = 7.59553 × 10⁻²⁴ | C₁₄ = −2.90130 × 10⁻²⁸ |

13th surface

| | |
|---|---|
| κ = 0 | |
| C₄ = 4.61119 × 10⁻⁸ | C₆ = −2.94123 × 10⁻¹² |
| C₈ = −3.08971 × 10⁻¹⁶ | C₁₀ = 3.40062 × 10⁻²⁰ |
| C₁₂ = −7.92879 × 10⁻²⁵ | C₁₄ = −3.73655 × 10⁻²⁹ |

20th surface

| | |
|---|---|
| κ = 0 | |
| C₄ = 7.74732 × 10⁻⁸ | C₆ = −1.87264 × 10⁻¹² |
| C₈ = 5.25870 × 10⁻¹⁸ | C₁₀ = 7.64495 × 10⁻²¹ |
| C₁₂ = −1.54608 × 10⁻²⁴ | C₁₄ = 1.16429 × 10⁻²⁸ |

23rd surface and 29th surface (identical surfaces)

| | |
|---|---|
| κ = 0 | |
| C₄ = 1.71787 × 10⁻⁸ | C₆ = −1.00831 × 10⁻¹² |
| C₈ = 6.81666 × 10⁻¹⁷ | C₁₀ = −4.54274 × 10⁻²¹ |
| C₁₂ = 2.14951 × 10⁻²⁵ | C₁₄ = −5.27655 × 10⁻³⁰ |

37th surface

| | |
|---|---|
| κ = 0 | |
| C₄ = −8.55990 × 10⁻⁸ | C₆ = 2.03164 × 10⁻¹² |
| C₈ = −1.01068 × 10⁻¹⁶ | C₁₀ = 4.37342 × 10⁻²¹ |
| C₁₂ = −5.20851 × 10⁻²⁵ | C₁₄ = 3.52294 × 10⁻²⁹ |

40th surface

| | |
|---|---|
| κ = 0 | |
| C₄ = −2.65087 × 10⁻⁸ | C₆ = 3.08588 × 10⁻¹² |
| C₈ = −1.60002 × 10⁻¹⁶ | C₁₀ = 4.28442 × 10⁻²¹ |
| C₁₂ = −1.49471 × 10⁻²⁵ | C₁₄ = 1.52838 × 10⁻²⁹ |

43rd surface

| | |
|---|---|
| κ = 0 | |
| C₄ = −8.13827 × 10⁻⁸ | C₆ = 2.93566 × 10⁻¹² |
| C₈ = −1.87648 × 10⁻¹⁶ | C₁₀ = 1.16989 × 10⁻²⁰ |
| C₁₂ = −3.92008 × 10⁻²⁵ | C₁₄ = 1.10470 × 10⁻²⁹ |

54th surface

| | |
|---|---|
| κ = 0 | |
| C₄ = −3.31812 × 10⁻⁸ | C₆ = −1.41360 × 10⁻¹² |
| C₈ = 1.50076 × 10⁻¹⁶ | C₁₀ = −1.60509 × 10⁻²⁰ |
| C₁₂ = 8.20119 × 10⁻²⁵ | C₁₄ = −2.18053 × 10⁻²⁹ |

FIG. 10 shows diagrams illustrating transverse aberrations in the second embodiment. It is understood that, in the second embodiment, similar to the first embodiment, chromatic aberrations are suitably corrected for the exposure light with the wavelength of 157.6244 nm±1 pm though relatively large image-side numerical aperture (NA=0.85) and projection field (effective diameter=28.8 nm) are secured.

As described above, in each of the embodiments, the image-side NA of 0.85 can be secured for the F₂ laser light with the center wavelength of 157.6244 nm, and the image circle with the effective diameter of 28.8 nm, in which various aberrations including the chromatic aberration are corrected sufficiently, can be secured on the wafer W. Accordingly, a high resolution of 0.1 μm or less can be attained while securing a rectangular effective exposure area of 25 mm×4 mm, which is sufficiently large.

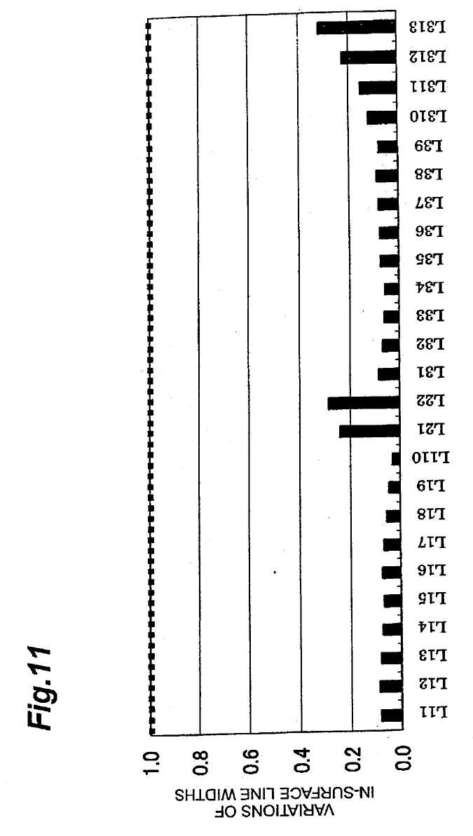

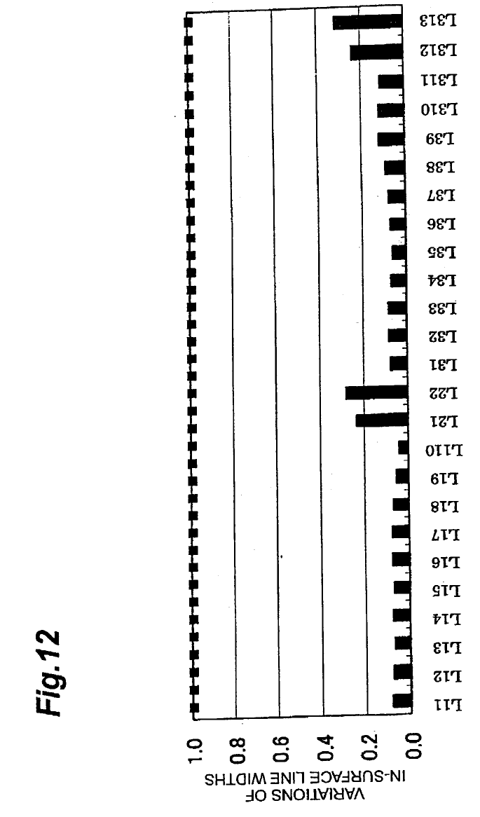

FIG. 11 is a graph showing variations of in-surface line widths when an angle difference of 1° is formed between the crystal axis and the optical axis of each fluorite lens in the first embodiment. Moreover, FIG. 12 is a graph showing variations of in-surface line widths when an angle difference of 1° is formed between the crystal axis and the optical axis of each fluorite lens in the second embodiment. In FIGS. 11 and 12, the horizontal line indicates the reference numerals for the respective fluorite lenses constituting the projection optical system PL. Moreover, the vertical line indicates variations of the in-surface line widths with the defined allowable value of 1 for line width variations when an angle difference of 1° is formed between the optical axis and the crystal axis C of each fluorite lens that should be coincided with the optical axis.

Referring to FIGS. 11 and 12, it is understood that the in-surface line widths are prone to be changed due to the effects of birefringence in each of the embodiments, particularly when the angle difference between the crystal axis C and the optical axis is formed in the lenses L313 and L312 arranged in the vicinity of the image surface (second surface) on which the wafer W is provided. Moreover, it is understood that the in-surface line widths are prone to be changed due to the effects of birefringence also when the angle difference between the crystal axis C and the optical axis is formed of the lenses L21 and L22 arranged in the bidirectional optical path on which the concave reflective mirror CM is formed.

Note that, as a result of the above-described simulations, it has been confirmed that it is possible to control the variations of the in-surface line widths approximately within 65% of the allowable value by controlling the angle difference between the crystal axis C and the optical axis within 1° in every fluorite lens that constitutes the projection optical system PL and that good image-forming performance can be obtained. Therefore, in each of the embodiments, good optical performance can be ensured virtually without effects of the birefringence of the fluorite by setting the angle difference at 1° or less between the optical axis and the crystal axis C in at least two fluorite lenses included in the projection optical system PL, and preferably, by setting the angle difference between the optical axis and the crystal axis C in every fluorite lens included in the projection optical system PL at 2° or less.

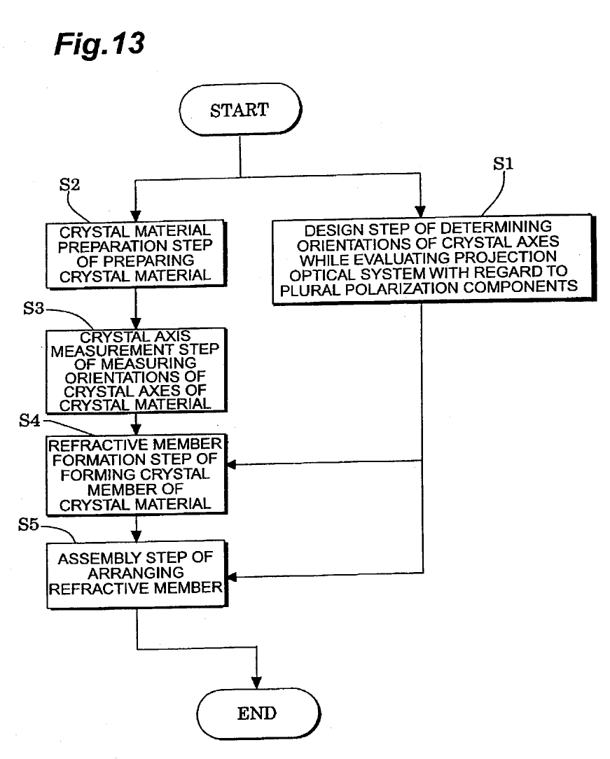

FIG. 13 is a flowchart schematically showing a fabrication method of the projection optical system according to the embodiments of the present invention. As shown in FIG. 13, the fabrication method of the embodiments includes the design step S1, the crystal material preparation step S2, the crystal axis measurement step S3, the refractive member formation step S4, and the assembly step S5. In the design step S1, when designing a projection optical system by using ray tracing software, ray tracing for the projection optical system is performed by using a ray with a plurality of polarized light components, and aberrations in the respective polarized light components, and preferably, a wavefront aberration for each polarized light component are calculated.

Then, while evaluating the projection optical system in terms of a scalar aberration which is a synthetic scalar component of an aberration for each of the plurality of polarized light components and the aberrations of the plurality of polarized light components, parameters of the plurality of optical members (refractive embers, reflective members, diffractive members and the like) constituting the projection optical system are optimized, thus acquiring design data composed of these parameters. As for such parameters, in addition to the conventional parameters including the surface shapes, surface intervals, refractive indices and the like of the optical members, the orientations of the crystal axes of the optical members are used as parameters when the optical members are made of a crystal material.

In the crystal material preparation step S2, a crystal material (fluorite in the embodiments) of a isometric system (crystal system where the unit lengths of the crystal axes are equal and all angles formed by the respective crystal axes at the intersections of the respective crystal axes are 90°), which is light-transmissive with respect to a wavelength (exposure light in the embodiments) used in the projection optical system, is prepared. In the crystal axis measurement step S3, the crystal axes of the crystal material prepared in the crystal material preparation step S2 are measured. In this case, for example, there can be applied a method for directly measuring the orientations of the crystal axes by using the Laue measurement or a method for defining the orientations of the crystal axes from the birefringence of the crystal material based on the already known relationship between the orientations of the crystal axes and the birefringence amounts by measuring the birefringence of the crystal material.

In the refractive member formation step S4, the crystal material prepared in the crystal material preparation step S2 is processed (polished) such that the refractive member has the parameters (design data) obtained in the design step. Note that, in the embodiments, the order of the crystal axis measurement step S3 and the refractive member formation step S4 could be reversed. For example, if the refractive member formation step S4 is conducted first, the crystal axes of the crystal material processed into the shape of the refractive member are satisfactorily measured. If the crystal axis measurement step S3 is conducted first, information on the orientations of the crystal axes is satisfactorily given to the refractive member or a holding member for holding the refractive member such that the measured crystal axes are recognized after forming the refractive

In the assembly step S5, the processed refractive member is incorporated into the lens barrel of the projection optical system in accordance with the design data obtained in the design step. In this case, the crystal axes of the refractive member composed of the crystal material of the isometric system are positioned so as to coincide with the orientations of the crystal axes in the design data obtained in the design step.

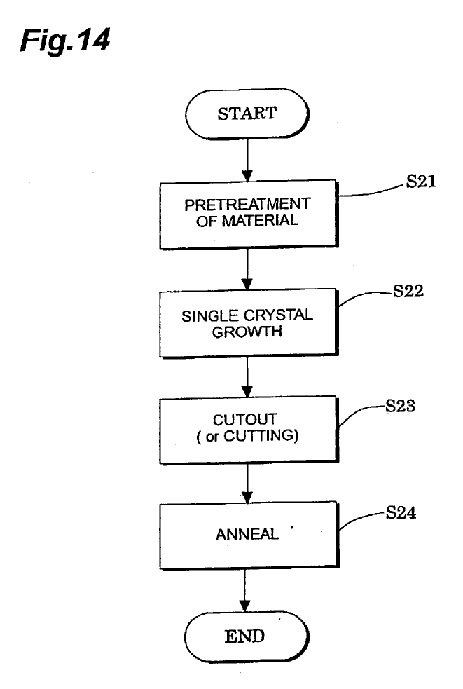

FIG. 14 is a flowchart specifically showing a crystal material preparation process of preparing a crystal material of an isometric system, which is light-transmissive with respect to a wavelength for which the projection optical system is used. Note that, as for such a crystal material of the isometric system, fluorite (calcium fluoride, CaF₂) and barium fluoride (BaF₂) are listed. In the following, the process will be described with the case of applying fluorite as the crystal material of the isometric system as an example.

Referring to FIG. 14, pretreatment is performed in the step S21 of the crystal material preparation process S2, in which a powder material is deoxidized. In the case of growing a single fluorite crystal used in the ultraviolet or vacuum ultraviolet range by the Bridgman method, a high-purity synthetic material is generally used. Furthermore, because the material becomes turbid and has a tendency to lose its transmissiveness when only the material is melted and crystallized, a scavenger is added thereto and the mixture is heated for preventing such turbidity. Lead fluoride (PbF₂) is typically used as a scavenger used for the pretreatment and growth of the single fluorite crystal.

Note that an additive which has a function to remove impurities contained in the material by reacting with the impurities is generally called a scavenger. In the pretreatment in the embodiments, a scavenger is added to the high-impurity powder material and mixed well. Thereafter, the deoxidizing reaction is accelerated by heating up the mixture to within the temperature range of more than or equal to the melting point of the scavenger and less than the melting point of the fluorite. Thereafter, the material may be directly cooled down to a room temperature and formed into a sintered body. Alternatively, the material may be cooled down to the room temperature and formed into a polycrystal after once melting the material by increasing the temperature further. The sintered body or the polycrystal thus deoxidized are called pretreated materials.

Next, in the step S22, a single crystal ingot is obtained through the crystal growth employing the pretreated material. It has been known that the method of crystal growth can be broadly divided into solidification of a melting solution, deposition from a solution, deposition from a gas and growth of a solid particle. In the embodiments, the crystal growth is conducted by the vertical Bridgman method. First, the pretreated material is incorporated in a vessel and placed at a predetermined position of a vertical Bridgman apparatus (crystal growth furnace). Thereafter, the pretreated material incorporated in the vessel is melted by heating. After reaching the melting point of the pretreated material, crystallization thereof is started after the elapse of a predetermined time. After the melting material is all crystallized, the crystal is annealed and taken out as an ingot.

In the step S23, the ingot is cut to obtain a disk material having approximately the same size and shape of an optical member to be obtained in the refractive member formation step S4 described later. Here, when the optical member to be obtained in the refractive member formation step S4 is a lens, it is preferable to form the shape of the disk material into a thin cylindrical shape, and it is desirable to set the aperture (diameter) and thickness of the cylindrical disk material in accordance with the effective diameter (outer diameter) and thickness in the optical axis direction of the lens. In the step S24, the disk material cut out of the single fluorite ingot is annealed. By executing these steps S21 to S24, a crystal material composed of the single fluorite crystal is obtained.

Next, the crystal axis measurement step S3 will be described. In the crystal axis measurement step S3, the crystal axis of the crystal material prepared in the crystal material preparation step S2 is measured. In this case, there are conceived the first measurement method for directly measuring the orientations of the crystal axes and the second measurement method for indirectly determining the orientations of the crystal axes by measuring the birefringence of the crystal material. First, the first measurement method for directly measuring the orientations of the crystal axes will be described. In the first measurement method, the crystal structure of the crystal material, and eventually the crystal axes are directly measured by using a method of an X-ray crystal analysis. As for such a measurement method, for example, the Laue method has been known.

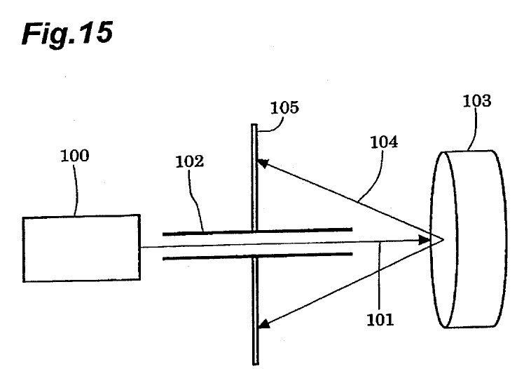

The case of applying the Laue method serving as the first measurement method will be briefly described below with reference to FIG. 15. FIG. 15 is a diagram schematically illustrating a Laue camera. As illustrated in FIG. 15, the Laue camera for realizing the crystal axis measurement according to the Laue method includes the X-ray source 100, the collimator 102 for guiding the X-ray 101 from the X-ray source 100 to the crystal material 103 as a sample, and the X-ray sensitive member 105 exposed by the diffracted X-ray 104 diffracted from the crystal material 103. Note that, though not being illustrated in FIG. 15, a pair of opposite slits is provided inside the collimator 102 penetrating the X-ray sensitive member 105.

In the first measurement method, first, the X-ray 101 is irradiated onto the crystal material 103 prepared in the crystal material preparation step S2, and the diffracted X-ray 104 is generated from the crystal material 103. Then, the X-ray sensitive member 105 such as an X-ray film and an imaging plate arranged on the X-ray incident side of the crystal material 103 is exposed by the diffracted X-ray 104. Then, a visible image (diffraction image) with a pattern corresponding to the crystal structure is formed on the X-ray sensitive member 105. This diffraction image (Laue diagram) exhibits spots when the crystal material is a single crystal, and the spots are called Laue spots. The crystal material for use in the embodiments is fluorite, and its crystal structure is already known. Therefore, the orientations of the crystal axes will be clarified by analyzing the Laue spots.

Note that the first measurement method for directly measuring the crystal axes is not limited to the Laue method. A rotation or vibration method for irradiating an X-ray while rotating or vibrating the crystal; other methods of the X-ray crystal analysis such as the Weissenberg method and the precession method; mechanical methods such as a method utilizing cleavage of the crystal material and a method for observing a pressure figure (or percussion figure) having a specific shape, which appears on the surface of the crystal material by giving a plastic deformation to the crystal material; and the like may be used.

Next, the second measurement method for indirectly determining the orientations of the crystal axes by measuring the birefringence of the crystal material will be briefly described. In the second measurement method, first, the orientations of the crystal axes of the crystal material, and the birefringence amounts in the orientations are made to correspond to each other. In this case, the orientations of the crystal axes of the sample of the crystal material are measured by use of the above-described first measurement method. Then, the birefringence is measured for each of the plurality of crystal axes of the crystal material sample.

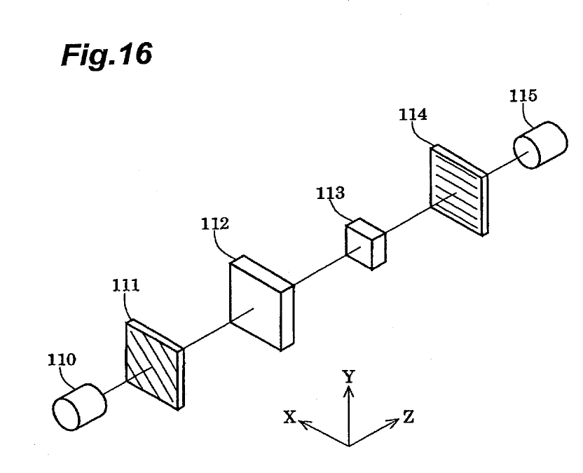

FIG. 16 is a diagram illustrating a schematic constitution of a birefringence measurement apparatus. In FIG. 16, light from the light source 110 is converted into linearly polarized light having a vibration plane tilted by π/4 from the horizontal direction (X direction) by the polarizer 111. Then, the linearly polarized light undergoes phase modulation by the photoelastic modulator 112, and is irradiated onto the crystal material sample 113. Specifically, the linearly polarized light of which phase is changed is made incident onto the crystal material sample 113. The light transmitted through the crystal material sample 113 is guided to the analyzer 114, and only polarized light having the vibration plane in the horizontal direction (X direction) transmits through the analyzer 114 and is detected by the photodetector 115.

In the case where predetermined phase delay is generated by the photoelastic modulator 112, directions of slow axes and refractive indices thereof, and refractive indices of fast axis can be obtained by measuring amount of light detected by photodetector 115 while changing the amount of the phase delay. Note that, when the birefringence exists in the sample, optical phases of two linearly polarized lights transmitting through the sample, in which the vibration planes (polarization planes) are orthogonal to each other, are changed due to a difference between the refractive indices. Specifically, the phase of one polarized light will be fast or slow with respect to the other polarized light. Thus, the polarization direction where the phase is fast is called a fast axis, and the polarization direction here the phase is slow is called a slow axis.

In the embodiments, the birefringence for each of the crystal axes of the crystal material sample, in which the orientations of the crystal axes have been already known by the above-described first measurement method, is measured, and the orientations of the crystal axes of the crystal material and the birefringence amounts in the orientations are made to correspond to each other. In this case, as the crystal axes of the crystal material, which is to be measured, the crystal axes such as [112], [210] and [211] may also be used besides the typical crystal axes such as [100], [110] and [111]. Note that the crystal axes [010] and [001] are crystal axes equivalent to the above-described crystal axis [100], and the crystal axes [011] and [101] are crystal axes equivalent to the above-described crystal axis [110]. Moreover, intermediate crystal axes between the measured crystal axes may be interpolated by use of a predetermined interpolation operation.

In the crystal axis measurement step S3 to which the second measurement method is applied, the birefringence of the crystal material prepared in the crystal material preparation step S2 is measured by use of the birefringence measurement apparatus illustrated in FIG. 16. Then, because a corresponding relationship between the orientations of the crystal axes and the birefringence is obtained beforehand, the orientations of the crystal axes are calculated from the measured birefringence by use of the corresponding relationship. Thus, according to the second measurement method, the orientations of the crystal axes of the crystal material can be obtained without directly measuring the orientations of the crystal axes.

Next, the refractive member formation step S4 will be described.

In the refractive member formation step S4, the crystal material prepared in the crystal material preparation step S2 is processed, and the optical member with a predetermined shape (lens and the like) is formed. In this case, any of the crystal axis measurement step S3 and the refractive member formation step S4 maybe performed first. For example, there are conceived the first member formation method for performing the refractive member formation step S4 after the crystal axis measurement step S3, the second member formation method for performing the crystal axis measurement step S3 after the refractive member measurement step S4, and the third member formation method for performing simultaneously the crystal axis measurement step S3 and the refractive member formation step S4.

First, the first member formation method will be described. In the first member formation method, a process such as a grinding and a polishing is performed for the disk material prepared in the crystal material preparation step S2 such that the optical member is formed in accordance with design data including the parameters regarding the orientations of the crystal axes, which are obtained in the design step S1. In this case, predetermined marks are provided on the processed optical member such that the orientations of the optical axes thereof are made apparent. Specifically, the refractive member constituting the projection optical system is fabricated by use of a material obtained by grinding the crystal material (typically, disk material) if necessary in which the orientations of the crystal axes are measured in the crystal material preparation step S2.

Specifically, the surface of each lens is polished in order to obtain the surface shape and the surface interval in the design data in accordance with the already known polishing step, and a refractive member having a lens surface of a predetermined shape is fabricated. In this case, the polishing is repeated while measuring the error of the surface shape of each lens by means of an interference meter, and the surface shape of each lens is made proximate to a target surface shape (best-fit spherical shape). When the surface shape error of each lens goes into a predetermined range in such a manner, the surface shape error of each lens is measured by use of, for example, an already known precise interference meter.

As above, the basic points regarding the fabrication method of the projection optical system according to the embodiments have been described. In the embodiments, in the design step S1, the design is made such that the optical axis of the fluorite lens as the light-transmissive crystal member coincides with the predetermined crystal axis such as the crystal axis [111], [100] or [110]. Then, in the fabrication steps (S2 to S4), the fluorite lens is fabricated such that the angle difference is set at 1° or less between the optical axis and the predetermined crystal axis to coincide with the optical axis.

Note that, in the fabrications steps (S2 to S4), it is preferable to make an adjustment such that the predetermined crystal axis and the optical axis are coincided in the event of cutting the disk material out of the single crystal ingot, and to make an adjustment such that the predetermined crystal axis and the optical axis are made to coincide with each other in the event of polishing the disk material. Moreover, for example, in order to further reduce the effects of birefringence of the fluorite, for example, in a pair of fluorite lenses constituting the pair of lenses with the optical axis [111], [100] or [111], it is preferable to set the angle difference of the relatively rotational angle thereof around the optical axis with respect to the predetermined design value (60°, 45° or 90°) at 1° or less.

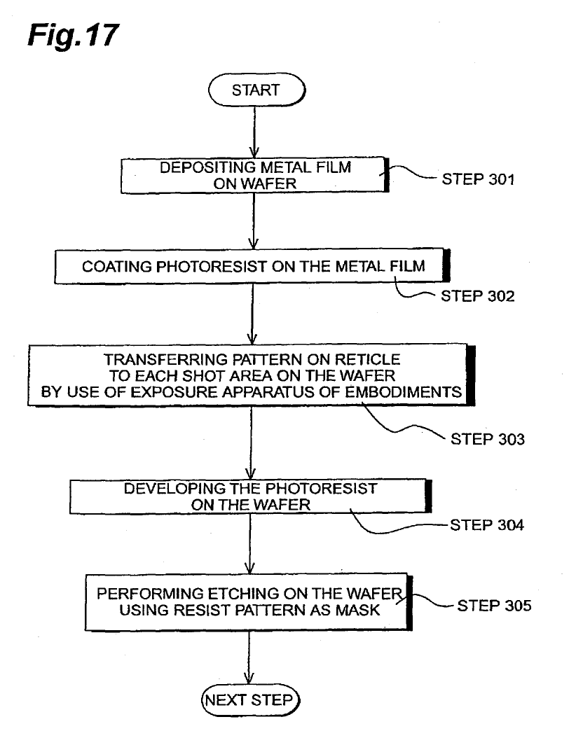

In the exposure apparatus of the above-described embodiments, the reticle (mask) is illuminated by the illumination apparatus (illumination step), and the pattern to be transferred, which is formed on the mask, is exposed on the photosensitive substrate by use of the projection optical system (exposure step), thus making it possible to fabricate the microdevices (semiconductor devices, imaging devices, liquid crystal display devices, thin-film magnetic heads and the like). With reference to the flowchart of FIG. 17, description will be given below for an example of a method for obtaining the semiconductor devices as the microdevices in such a manner that a predetermined circuit pattern is formed on a wafer or the like as a photosensitive substrate by using the exposure apparatus of the embodiments.

First, in the step 301 of FIG. 17, a metal film is deposited on one lot of wafers. In the next step 302, photoresist is applied on the metal film on the one lot of wafers. Thereafter, in the step 303, a pattern image on the mask is sequentially exposed and transferred on each shot area on the one lot of wafers through the projection optical system by using the exposure apparatus of the embodiments. Thereafter, the photoresist on the one lot of wafers is developed in the step 304. Then, in the step 305, etching is performed using the resist pattern as a mask on the one lot of wafers. Thus, the circuit pattern corresponding to the pattern on the mask is formed on each shot area on each wafer.

Thereafter, a circuit pattern on an upper layer is further formed and so on, and thus devices such as the semiconductor devices are fabricated. According to the above-described semiconductor device fabrication method, semiconductor devices, each having an extremely microcircuit pattern, can be obtained with good throughput. Note that, in the steps 301 to 305, the steps are performed, which include the deposition of metal on a wafer, coating of resist on a film of the metal, exposure, development and etching. It is needless to say that, prior to these steps, an oxidation film of silicon may be formed on the wafer, and the respective steps of coating resist on the oxidation film of silicon, exposure, development, etching and the like may be performed.

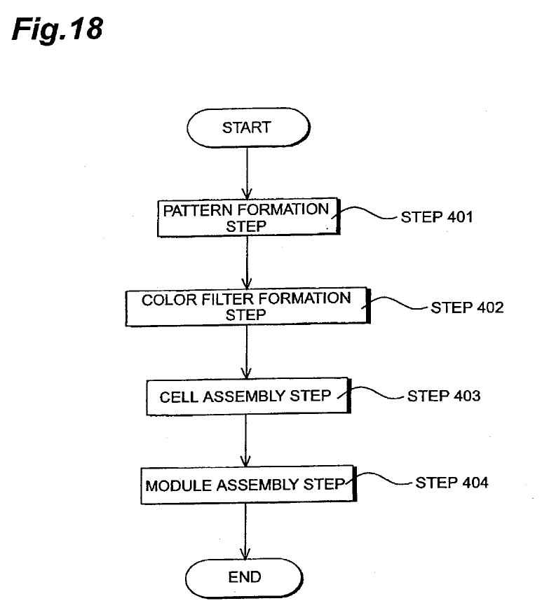

Moreover, in the exposure apparatus of the embodiments, a predetermined pattern (circuit pattern, electrode pattern) is formed on a plate (glass substrate), thus making it possible to obtain the liquid crystal display devices, which are microdevices. An example of a method in this case will be described below with reference to the flowchart of FIG. 18. In FIG. 18, in the pattern formation step 401, executed is a so-called photolithography step of transferring and exposing a mask pattern on a photosensitive substrate (glass substrate or the like coated with resist) by use of the exposure apparatus of the embodiments. By this photolithography step, the predetermined pattern including a large number of electrodes is formed on the photosensitive substrate. Thereafter, the exposed substrates passes through the respective steps of development, etching, resist delamination and the like, and thus the predetermined pattern is formed on the substrate. Then, the method proceeds to the color filter formation step 402.

Next, in the color filter formation step 402, a color filter is formed, in which a large number of sets, each having three dots corresponding to R (Red), G (Green) and B (Blue), are arrayed in a matrix, or plural filter sets, each having three stripes of R, G and B, are arrayed in a horizontal scanning direction. Then, after the color filter formation step 402, the cell assembly step 403 is executed. In the cell assembly step 403, a liquid crystal panel (liquid crystal cell) is assembled by use of the substrate having the predetermined pattern, which is obtained in the pattern formation step 401, the color filter obtained in the color filter formation step 402, and the like. In the cell assembly step 403, for example, liquid crystal is injected between the substrate having the predetermined pattern, which is obtained in the pattern formation step 401, and the color filter obtained in the color filter formation step 402, thus fabricating the liquid crystal panel (liquid crystal cell).

Thereafter, in the module assembly step 404, the respective parts such as an electric circuit allowing the assembled liquid crystal panel (liquid crystal cell) to perform a display operation and a backlight are installed, thus completing the liquid crystal display device. According to the above-described fabrication method of the liquid crystal display device, the liquid crystal display device having an extremely microscopic circuit pattern can be obtained with good throughput.

Note that, though the present invention is applied to the projection optical system mounted on the exposure apparatus in the above-described embodiments, the present invention can also be applied to other general projection optical systems without being limited to the above. Moreover, though the F₂ laser light source is used in the above-described embodiments, for example, other suitable light sources, each supplying light of a wavelength of 200 nm or less, can also be used without being limited to the above.

Moreover, in the above-described embodiments, the present invention is applied to the exposure apparatus of a step-and-scan system in which a mask pattern is scanned and exposed for each exposure area of the substrate while moving the mask and the substrate relative to the projection optical system. However, the present invention can also be applied to an exposure apparatus of a step-and-repeat system in which the mask pattern is transferred to the substrate in a lump in a state where the mask and the substrate are made still and the mask pattern is sequentially exposed to each exposure area by sequentially moving the substrate step by step without being limited to the above.

Furthermore, though the aperture stop is arranged in the third image-forming optical system in the above-described embodiments, the aperture stop may be arranged in the first image-forming optical system. Moreover, the aperture stop may be arranged on at least one of the intermediate image position between the first image-forming optical system and the second image-forming optical system and the intermediate image position between the second image-forming optical system and the third image-forming optical system.

As described above, in the projection optical system of the present invention, for example, the angle difference is set at 1° or less between the optical axis and predetermined crystal axis of the fluorite lens serving as the light-transmissive crystal member, thus making it possible to ensure good optical performance virtually without effects of the birefringence of the fluorite. Moreover, in the projection optical system of the present invention, for example, the relative angle difference is controlled to 2° or less between the crystal axis orientations in the abnormal fluorite crystals for use in forming the fluorite lens, thus making it possible to ensure good optical performance virtually without effects of the birefringence of fluorite.

Accordingly, in the exposure apparatus and the exposure method, which use the projection optical system having good optical performance virtually without effects of the birefringence of the fluorite, high-resolution and high-precision projection and exposure can be performed. Moreover, high-precision projection and exposure is performed through the high-resolution projection optical system by use of the exposure apparatus mounting the projection optical system of the present invention, thus making it possible to fabricate good microdevices.

From the invention thus described, it will be obvious that the embodiments of the invention may be varied in many ways. Such variations are not to be regarded as a departure from the spirit and scope of the invention, and all such modifications as would be obvious to one skilled in the art are intended for inclusion within the scope of the following claims.

What is claimed is:

1. A projection optical system for forming an image of a first surface on a second surface, comprising:
at least two light-transmissive crystal members formed of a crystal material belonging to a cubic system,
wherein at least one of an angle difference between an optical axis and any one of crystal axes [111], [100] and [110] in at least the two light-transmissive crystal members and an angle difference of a relatively rotational angle between predetermined crystal axes around the optical axis from a predetermined value in at least the two light-transmissive crystal members is set at 1° or less.

2. The projection optical system according to claim 1, wherein the angle difference is set at 1° or less between the optical axis and any one of the crystal axes [111], [100] and [110] in at least the two light-transmissive crystal members.

3. The projection optical system according to claim 2, further comprising: a concave reflective mirror; and a light-transmissive crystal member arranged in a vicinity of the concave reflective mirror,
wherein an angle difference is set at 1° or less between an optical axis and any one of crystal axes [111], [100] and [110] in the light-transmissive crystal member arranged in the vicinity of the concave reflective mirror.

4. The projection optical system according to claim 3, wherein the projection optical system is a catadioptric and image re-forming optical system for forming an intermediate image of the image of the first surface in an optical path between the first surface and the second surface.

5. The projection optical system according to claim 4, further comprising: a first image-forming optical system for forming a first intermediate image of the image of the first surface; a second image-forming optical system including at least one concave reflective mirror and at least one light-transmissive crystal member and for forming a second intermediate image based on a light beam from the first intermediate image; a third image-forming optical system for forming a final image on the second surface based on a light beam from the second intermediate image; a first deflection mirror arranged in an optical path between the first image-forming optical system and the second image-forming optical system; and a second deflection mirror arranged in an optical path between the second image-forming optical system and the third image-forming optical system,
wherein an optical axis of the first image-forming optical system and an optical axis of the third image-forming optical system are set to virtually coincide, and
an angle difference is set at 1° or less between an optical axis and any one of crystal axes [111], [100] and [110] in the light-transmissive crystal member arranged in an optical path of the second image-forming optical system.

6. The projection optical system according to claim 5, wherein an angle difference is set at 1° or less between an optical axis and anyone of crystal axes [111], [100] and [110] in more than or equal to 15% of all the light-transmissive crystal members included in the projection optical system.

7. The projection optical system according to claim 5, wherein an angle difference is set at 2° or less between an optical axis and any one of crystal axes [111], [100] and [110] in all the light-transmissive crystal members included in the projection optical system.

8. The projection optical system according to claim 3, further comprising: a first image-forming optical system for forming a first intermediate image of the image of the first surface; a second image-forming optical system including at least one concave reflective mirror and at least one light-transmissive crystal member and for forming a second intermediate image based on a light beam from the first intermediate image; a third image-forming optical system for forming a final image on the second surface based on a light beam from the second intermediate image; a first deflection mirror arranged in an optical path between the first image-forming optical system and the second image-forming optical system; and a second deflection mirror arranged in an optical path between the second image-forming optical system and the third image-forming optical system,
wherein an optical axis of the first image-forming optical system and an optical axis of the third image-forming optical system are set to virtually coincide, and
an angle difference is set at 1° or less between an optical axis and any one of crystal axes [111], [100] and [110] in the light-transmissive crystal member arranged in an optical path of the second image-forming optical system.

9. The projection optical system according to claim 8, wherein an angle difference is set at 1° or less between an optical axis and any one of crystal axes [111], [100] and [110] in more than or equal to 15% of all the light-transmissive crystal members included in the projection optical system.

10. The projection optical system according to claim 3, wherein an angle difference is set at 1° or less between an optical axis and any one of crystal axes [111], [100] and [110] in more than or equal to 15% of all the light-transmissive crystal members included in the projection optical system.

11. The projection optical system according to claim 2, further comprising a light-transmissive crystal member arranged closest to the second surface,
wherein an angle difference is set at 1° or less between an optical axis and any one of crystal axes [111], [100] and [110] in the light-transmissive crystal member arranged closest to the second surface.

12. The projection optical system according to claim 11, further comprising: a concave reflective mirror; and a light-transmissive crystal member arranged in a vicinity of the concave reflective mirror,
wherein an angle difference is set at 1° or less between an optical axis and any one of crystal axes [111], [100] and [110] in the light-transmissive crystal member arranged in the vicinity of the concave reflective mirror.

13. The projection optical system according to claim 12, wherein the projection optical system is a catadioptric and image re-forming optical system for forming an intermediate image of the image of the first surface in an optical path between the first surface and the second surface.

14. The projection optical system according to claim 13, wherein an angle difference is set at 1° or less between an optical axis and any one of crystal axes [111], [100] and [110] in more than or equal to 15% of all the light-transmissive crystal members included in the projection optical system.

15. The projection optical system according to claim 14, wherein an angle difference is set at 2° or less between an optical axis and any one of crystal axes [111], [100] and [110] in all the light-transmissive crystal members included in the projection optical system.

16. The projection optical system according to claim 11, further comprising: a first image-forming optical system for forming a first intermediate image of the image of the first surface; a second image-forming optical system including at least one concave reflective mirror and at least one light-transmissive crystal member and for forming a second intermediate image based on a light beam from the first intermediate image; a third image-forming optical system for forming a final image on the second surface based on a light beam from the second intermediate image; a first deflection mirror arranged in an optical path between the first image-forming optical system and the second image-forming optical system; and a second deflection mirror arranged in an optical path between the second image-forming optical system and the third image-forming optical system,
wherein an optical axis of the first image-forming optical system and an optical axis of the third image-forming optical system are set to virtually coincide, and
an angle difference is set at 1° or less between an optical axis and any one of crystal axes [111], [100] and [110] in the light-transmissive crystal member arranged in an optical path of the second image-forming optical system.

17. The projection optical system according to claim 2, further comprising: a first image-forming optical system for forming a first intermediate image of the image of the first surface; a second image-forming optical system including at least one concave reflective mirror and at least one light-transmissive crystal member and for forming a second intermediate image based on a light beam from the first intermediate image; a third image-forming optical system for forming a final image on the second surface based on a light beam from the second intermediate image; a first deflection mirror arranged in an optical path between the first image-forming optical system and the second image-forming optical system; and a second deflection mirror arranged in an optical path between the second image-forming optical system and the third image-forming optical system,
wherein an optical axis of the first image-forming optical system and an optical axis of the third image-forming optical system are set to virtually coincide, and
an angle difference is set at 1° or less between an optical axis and any one of crystal axes [111], [100] and [110] in the light-transmissive crystal member arranged in an optical path of the second image-forming optical system.

18. The projection optical system according to claim 2, wherein an angle difference is set at 1° or less between an optical axis and any one of crystal axes [111], [100] and [110] in more than or equal to 15% of all the light-transmissive crystal members included in the projection optical system.

19. The projection optical system according to claim 2, wherein an angle difference is set at 2° or less between an optical axis and any one of crystal axes [111], [100] and [110] in all the light-transmissive crystal members included in the projection optical system.

20. The projection optical system according to claim 2, wherein the crystal material belonging to the cubic system is any of calcium fluoride and barium fluoride.

21. An exposure apparatus comprising: an illumination system for illuminating a mask set on the first surface; and the projection optical system according to claim 1 for forming a pattern image formed on the mask on a photosensitive substrate set on the second surface.

22. An exposure method comprising the steps of: illuminating a mask on the first surface; and projecting and exposing a pattern image formed on the mask through the projection optical system according to claim 1 on a photosensitive substrate set on the second surface.

23. A projection optical system for forming an image of a first surface on a second surface, comprising:
at least two light-transmissive crystal members formed of a crystal material belonging to a cubic system,
wherein, when an area having a difference between orientations of crystal axes exists in at least the two light-transmissive crystal members, relative angle difference thereof is 2° or less.

24. The projection optical system according to claim 23, further comprising a light-transmissive crystal member arranged closest to the second surface,
wherein, when an area having a difference between orientations of crystal axes exists in the light-transmissive crystal member arranged closest to the second surface, relative angle difference thereof is 2° or less.

25. The projection optical system according to claim 24, further comprising: a concave reflective mirror; and a light-transmissive crystal member arranged in a vicinity of the concave reflective mirror,
wherein, when an area having a difference between orientations of crystal axes exists in the light-transmissive crystal member arranged in the vicinity of the concave reflective mirror, relative angle difference thereof is 2° or less.

26. The projection optical system according to claim 25, wherein the projection optical system is a catadioptric and image re-forming optical system for forming an intermediate image of the image of the first surface in an optical path between the first surface and the second surface.

27. The projection optical system according to claim 26, wherein, when an area having a difference between orientations of crystal axes exits in all the light-transmissive crystal members included in the projection optical system, relative angle difference thereof is 2° or less.

28. The projection optical system according to claim 25, further comprising: a first image-forming optical system for forming a first intermediate image of the image of the first surface; a second image-forming optical system including at least one concave reflective mirror and at least one light-transmissive crystal member and for forming a second intermediate image based on a light beam from the first intermediate image; a third image-forming optical system for forming a final image on the second surface based on a light beam from the second intermediate image; a first deflection mirror arranged in an optical path between the first image-forming optical system and the second image-forming optical system; and a second deflection mirror arranged in an optical path between the second image-forming optical system and the third image-forming optical system,
wherein an optical axis of the first image-forming optical system and an optical axis of the third image-forming optical system are set to virtually coincide, and
when an area having a difference between orientations of crystal axes exists in the light-transmissive crystal member arranged in the optical path of the second image-forming optical system, relative angle difference thereof is 2° or less.

29. The projection optical system according to claim 28, wherein, when an area having a difference between orientations of crystal axes exits in all the light-transmissive crystal members included in the projection optical system, relative angle difference thereof is 2° or less.

30. The projection optical system according to claim 24, wherein, when an area having a difference between orientations of crystal axes exists in all the light-transmissive crystal members included in the projection optical system, relative angle difference thereof is 2° or less.

31. The projection optical system according to claim 23, further comprising: a concave reflective mirror; and a light-transmissive crystal member arranged in a vicinity of the concave reflective mirror,
wherein, when an area having a difference between orientations of crystal axes exists in the light-transmissive crystal member arranged in the vicinity of the concave reflective mirror, relative angle difference thereof is 2° or less.

32. The projection optical system according to claim 31, wherein the projection optical system is a catadioptric and image re-forming optical system for forming an intermediate image of the image of the first surface in an optical path between the first surface and the second surface.

33. The projection optical system according to claim 31, further comprising: a first image-forming optical system for forming a first intermediate image of the image of the first surface; a second image-forming optical system including at least one concave reflective mirror and at least one light-transmissive crystal member and for forming a second intermediate image based on a light beam from the first intermediate image; a third image-forming optical system for forming a final image on the second surface based on a light beam from the second intermediate image; a first deflection mirror arranged in an optical path between the first image-forming optical system and the second image-forming optical system; and a second deflection mirror arranged in an optical path between the second image-forming optical system and the third image-forming optical system,
wherein an optical axis of the first image-forming optical system and an optical axis of the third image-forming optical system are set to virtually coincide, and
when an area having a difference between orientations of crystal axes exists in the light-transmissive crystal member arranged in the optical path of the second image-forming optical system, relative angle difference thereof is 2° or less.

34. The projection optical system according to claim 31, wherein, when an area having a difference between orientations of crystal axes exists in all the light-transmissive crystal members included in the projection optical system, relative angle difference thereof is 2° or less.

35. The projection optical system according to claim 23, further comprising: a first image-forming optical system for forming a first intermediate image of the image of the first surface; a second image-forming optical system including at least one concave reflective mirror and at least one light-transmissive crystal member and for forming a second intermediate image based on a light beam from the first intermediate image; a third image-forming optical system for forming a final image on the second surface based on a light beam from the second intermediate image; a first deflection mirror arranged in an optical path between the first image-forming optical system and the second image-forming optical system; and a second deflection mirror arranged in an optical path between the second image-forming optical system and the third image-forming optical system,
wherein an optical axis of the first image-forming optical system and an optical axis of the third image-forming optical system are set to virtually coincide, and when an area having a difference between orientations of crystal axes exists in the light-transmissive crystal member arranged in the optical path of the second image-forming optical system, relative angle difference thereof is 2° or less.

36. The projection optical system according to claim 23, wherein, when an area having a difference between orientations of crystal axes exists in all the light-transmissive crystal members included in the projection optical system, relative angle difference thereof is 2° or less.

37. The projection optical system according to claim 23, wherein the crystal material belonging to the cubic system is any of calcium fluoride and barium fluoride.

38. An exposure apparatus comprising: an illumination system for illuminating a mask set on the first surface; and the projection optical system according to claim 23 for forming a pattern image formed on the mask on a photosensitive substrate set on the second surface.

39. An exposure method comprising the steps of: illuminating a mask set on the first surface; and projecting and exposing a pattern image formed on the mask through the projection optical system according to claim 23 on a photosensitive substrate set on the second surface.

40. A fabrication method of a projection optical system including at least two light-transmissive crystal embers formed of a crystal material belonging to a cubic system and for forming an image of a first surface on a second surface, the method comprising:
a design step of designing to allow an optical axis of each of at least the two light-transmissive crystal members to coincide with any one predetermined crystal axis of crystal axes [111], [100] and [110]; and
a fabrication step of fabricating at least the two light-transmissive crystal members such that an angle difference is set at 1° or less between the predetermined crystal axis and the optical axis.

41. The fabrication method according to claim 40, wherein the fabrication step includes the steps of: adjusting a cutout of a disk material from a single crystal ingot; and adjusting a polishing of the disk material.

42. The fabrication method according to claim 41,
wherein at least the two light-transmissive crystal members include first and second light-transmissive crystal members, and
the fabrication step includes a setting step of setting an angle difference of a relatively rotational angle at 5° or less between the predetermined crystal axes of the first and second light-transmissive crystal members around the optical axis with respect to a predetermined design value.

43. The fabrication method according to claim 40,
wherein at least the two light-transmissive crystal members include first and second light-transmissive crystal members, and
the fabrication step includes a setting step of setting an angle difference of a relatively rotational angle at 5° or less between the predetermined crystal axes of the first and second light-transmissive crystal members around the optical axis with respect to a predetermined design value.

44. An exposure apparatus comprising: an illumination system for illuminating a mask set on the first surface; and the projection optical system fabricated by the fabrication method according to claim 40 for forming a pattern image formed on the mask on a photosensitive substrate set on the second surface.

45. An exposure method comprising the steps of: illuminating a mask set on the first surface; and projecting and exposing a pattern image formed on the mask through the projection optical system fabricated by the fabrication method according to claim 40 on a photosensitive substrate set on the second surface.

46. An optical system comprising:
at least the two light-transmissive crystal members formed of a crystal material belonging to a cubic system,
wherein at least one of an angle difference between an optical axis and any one of crystal axes [111], [100] and [110] in at least the two light-transmissive crystal members and an angle difference of a relatively rotational angle between predetermined crystal axes around the optical axis from a predetermined value in at least the two light-transmissive crystal members is set at 1° or less.

47. An optical system comprising:
at least two light-transmissive crystal members formed of a crystal material belonging to a cubic system,
wherein, when an area having a difference between orientations of crystal axes exists in at least the two light-transmissive crystal members, relative angle difference thereof is 2° or less.

48. A fabrication method of a projection optical system including at least two light-transmissive crystal members formed of a crystal material belonging to a cubic system and for forming an image of a first surface on a second surface, the method comprising:
a design step of designing to allow an optical axis of each of at least the two light-transmissive crystal members to coincide with any one predetermined crystal axis of crystal axes [111], [100] and [110]; and
a fabrication step of fabricating at least the two light-transmissive crystal hers such that an angle difference is set at 1° or less between the predetermined crystal axis and the optical axis.
